(19) United States
(12) Patent Application Publication
(10) Pub. No.: US 2018/0234875 A1
(43) Pub. Date: Aug. 16, 2018

(54) High Efficiency Small Cell Fronthaul Systems and Methods

(71) Applicant: EBlink BVBA, Antwerpen (BE)

(72) Inventor: Frederic Leroudier, Pleasanton, CA (US)

(21) Appl. No.: 15/954,494

(22) Filed: Apr. 16, 2018

Related U.S. Application Data
(63) Continuation-in-part of application No. 14/311,186, filed on Jun. 20, 2014, now Pat. No. 10,009,790.
Application No. 14/311,186 is a continuation of application No. 13/732,273, filed on Dec. 31, 2012, now Pat. No. 8,761,141.

(30) Foreign Application Priority Data
May 4, 2012 (FR) 1254139

(51) Int. Cl. H04W 28/02; H04W 88/08; H04L 25/02; H04W 72/04; H04W 24/00; H04L 5/00

(52) U.S. Cl. CPC H04W 28/0247; H04W 88/085; H04L 25/02; H04L 5/0001; H04W 24/00; H04W 72/0453

(57) ABSTRACT

Systems and methods for efficiently transmitting information over small cell networks are provided herein. An exemplary method may include allocating wireless resources to a plurality of wireless endpoints by applying a network schedule using a centralized baseband unit, and transmitting, by the baseband unit, fronthaul data over wireless links to the plurality of wireless endpoints based on the allocated wireless resources and the network schedule.

### CROSS-REFERENCE TO RELATED APPLICATIONS

This patent application is a continuation-in-part of U.S. Nonprovisional patent application Ser. No. 14/311,186, filed on Jun. 20, 2014, which is a continuation of U.S. Nonprovisional patent application Ser. No. 13/732,273, filed on Dec. 31, 2012, now U.S. Pat. No. 8,761,141, issued on Jun. 24, 2014, which claims foreign priority benefit of French Patent Application Number 1254139, filed on May 4, 2012, now French Patent Number 2990315, issued on Nov. 8, 2013, all of which are hereby incorporated herein their entireties including all reference cited therein. This patent application is related to U.S. Nonprovisional patent application Ser. No. 14/318,446, filed on Jun. 27, 2014, which is a continuation of U.S. Nonprovisional patent application Ser. No. 13/735,903, filed on Jan. 7, 2013, now U.S. Pat. No. 9,020,070 issued on Apr. 28, 2015, which claims foreign priority benefit of French Patent Application Number 1254139, filed on May 4, 2012, now French Patent Number 2990315, issued on Nov. 8, 2013, all of which are hereby incorporated herein their entireties including all reference cited therein.

### FIELD OF THE INVENTION

The present technology may be generally described as providing efficient methods for efficiently transmitting fronthaul data in small cell networks and other telecommunication networks.

### BACKGROUND

Transmitting data across a wired network, such as a fiber network allows for high capacity and high velocity data transmission. Unfortunately, wired networks may be limited in geographical reach. Wireless networks allow for data transmission into locales where wired networks are unavailable. Wireless networks are bandwidth limited and thus do not currently provide the data transmission capacity and velocity afforded by wired networks.

Also, Mobile Radio Access Networks (RANs) increasingly rely on high capacity wide area transport networks to interconnect mobile transceivers and baseband processing resources. Transmitting data across a wired network, such as a fiber network allows for high capacity and high speed data transmission. Unfortunately, wired networks may be limited in geographical reach and often require high costs to build and operate. Wireless networks allow for data transmission into locales where wired networks are unavailable. Wireless networks are bandwidth limited and thus do not currently provide the data transmission capacity and velocity afforded by wired networks.

What is needed are wide area transport networks that comprise both wired and wireless network segments. Further, these wide area transport networks should allow for selective transmission of fronthaul data flow in either multiplexed or demultiplexed forms depending on performance aspects (e.g., key performance indicators) of network segments of the mobile wireless network.

### SUMMARY

According to some embodiments, the present technology may be directed to a system, comprising: (a) a plurality of remote fronthaul unit equipment devices, each coupled with at least one remote radio transceiver and transmitting and receiving fronthaul data to and from the at least one remote radio transceiver; and (b) a fronthaul hub that is coupled to a baseband unit at a first location that is coupled to the plurality of remote fronthaul units equipment devices over fronthaul links, the fronthaul hub managing allocation of fronthaul resources to the plurality of remote fronthaul units equipment devices and transmitting and receiving fronthaul data to the plurality of remote fronthaul units equipment devices using a multiplexing schema, the fronthaul data comprising control and management data, user data and digital RF carrier signals.

A method, comprising: (a) allocating fronthaul resources to a plurality of fronthaul endpoints by applying a network multiplexing or schedule using a fronthaul hub unit communicatively coupled with a centralized baseband unit; and (b) transmitting, by the fronthaul hub, fronthaul data over fronthaul links to the plurality of remote fronthaul unit equipment devices based on the allocated fronthaul resources and the network multiplexing scheme or schedule.

According to some embodiments, the present technology may be directed to a system that comprises a hub communicatively coupled with a baseband unit and a plurality of fronthaul remotes coupled with remote radio transceivers over communications links, each communications links is used to transport fronthaul data towards the remote radio transceivers which comprise at least one radio frequency transceiver, wherein fronthaul resources are allocated using multiplexing or network scheduling and at least one resource allocation schema.

Some embodiments comprise computer readable media that are encoded with logic that perform one or more of the methods described herein.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a block diagram of an exemplary wide area transport network in which embodiments of the present technology may be practiced;

FIG. 2A is an exemplary wide area transport network;

FIG. 2B illustrates an exemplary functional implementation of a fronthaul module according to the present technology;

FIG. 2C illustrates another exemplary fronthaul module constructed in accordance with the present technology;

FIG. 3 is another exemplary wide area transport network;

FIG. 4 is a schematic representation of a base station structure implementing the method for transmitting information according to the invention;

FIG. 5 is a schematic representation of the transmitting of information between two units of the base station of FIG. 4;

FIG. 6 is a schematic representation of the transmitting of information between two units of the base station of FIG. 4;

FIG. 7 is a schematic representation of the transmission information according to the present technology at the level of a transmitter;

FIG. 8 is a schematic representation of the transmission information according to the present technology at the level of a receiver;

FIGS. 9A and 9B are flowcharts of an exemplary method for transmitting information

FIG. 10 is a schematic diagram of an example computing device for use in accordance with the present disclosure.

FIG. 11 is an example schematic diagram of a system that efficiently transmits fronthaul data to small cell networks.

FIG. 12 includes graphs that illustrate wireless resource allocation such as a multitude of LTE Resource Blocks in frequency and/or time domains.

FIG. 13 includes graphs that illustrate cooperative allocation of wireless resources using a frequency domain.

FIG. 14 illustrates static, coordinated, and statistical methods for allocation in systems where multiplexing of the fronthaul channels is either orthogonal or not fully orthogonal.

FIG. 15 is a schematic diagram of another example system that efficiently transmits fronthaul data to small cell networks.

FIG.16 is a flowchart of an example method for efficient transmission of fronthaul data to small cell networks.

### DESCRIPTION OF EXEMPLARY EMBODIMENTS

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

Generally speaking, the present technology may be directed to wide area transport networks, also referred to as hybrid cloud radio access network transport architectures. Broadly, hybrid networks of the present technology may be built upon a variety of network topologies that allow for the transmission of mobile network fronthaul signals, control management protocol elements, and user digital data flow. The hybrid network may include combinations of fiber optic networks, electric cable networks, along with other types of wired networks that would be known to one of ordinary skill in the art with the present disclosure before them. These wired networks may be communicatively coupled with one or more wireless networks that extend the reach of the wired networks. That is, wired networks are inherently limited in geographical scope. Physical linkages required in a wired network prevent connecting of locations that are inaccessible or impractical for wired media. For example, a centralized metropolitan city may easily access a wired fiber ring, whereas it may be impractical to extend a fiber spoke from the fiber hub out to a rural community. Similarly, a wired network may provide connectivity along a route, but connecting elements situated at a distance from this route would require an extension of this wired network, or the use of complementary techniques. Thus, the reach of a wired network can be extended by the inclusion of wireless networks.

While wireless networks can extend the reach of wired networks, these wireless networks may not be capable of facilitating the same capacity and velocity of data transfer as a wired network. Thus, the hybrid networks of the present technology may allow for the selective transmission of fronthaul data flow across the hybrid network in a manner which is both efficient in coverage and capacity. The hybrid network may selectively separate and reassemble (e.g., via, for example, multiplexing or demultiplexing) fronthaul data flow as needed, based upon key performance indicators or design objectives for each segment of the network. For example, demultiplexing of fronthaul data flow and separate processing of the various components of the flow may allow for high capacity fronthaul data to be transmitted efficiently over a bandwidth-limited wireless network segment by using different transmission methods for the demultiplexed flows.

In accordance with the present technology, RF signals (that may be digitally coded as in-phase and quadrature signals (I/Q)) may be transported within the Mobile Radio Access Network, alongside general information (such as control and management protocol elements) and user data flow (such as user data traffic over local area networks associated with a particular mobile wireless transceiver site and equipment). The RF signals may be transported as analog signals corresponding to the RF carriers modulated as per a corresponding Radio Access Technology (RAT), while general control and management protocol elements and user data flows may be transported as digitally encoded and modulated signals.

These and other advantages of the present technology will be discussed in greater detail herein.

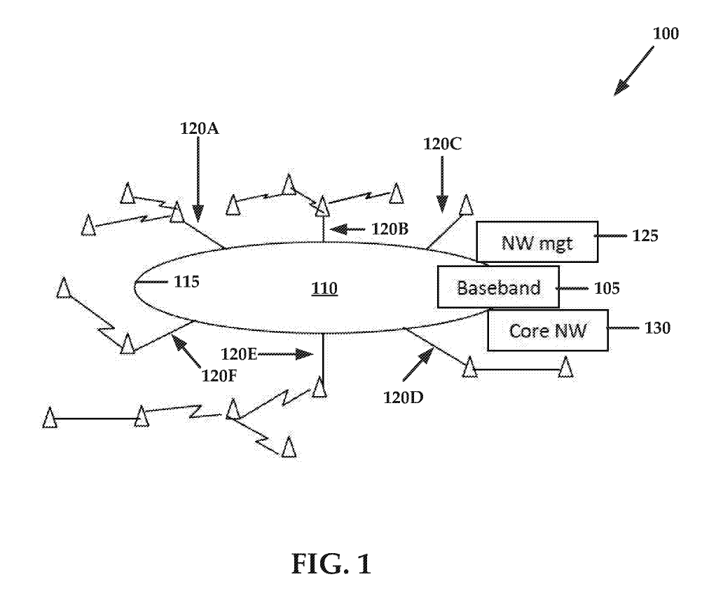

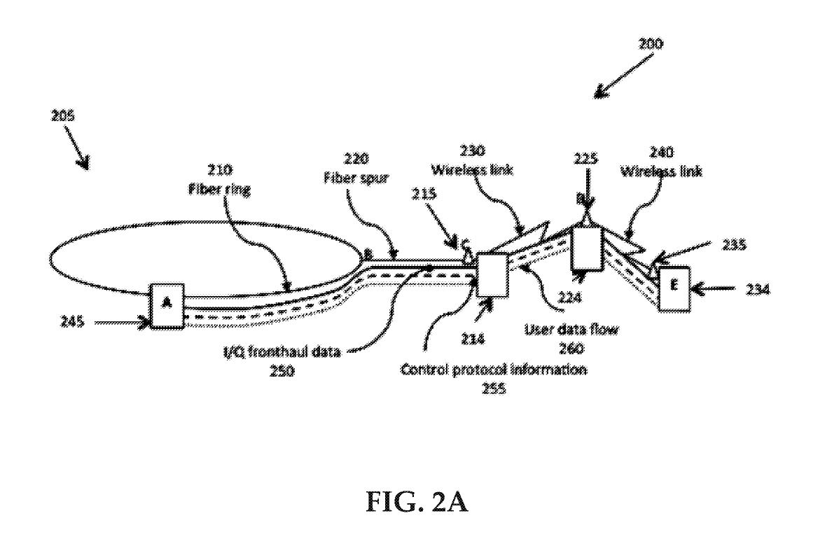

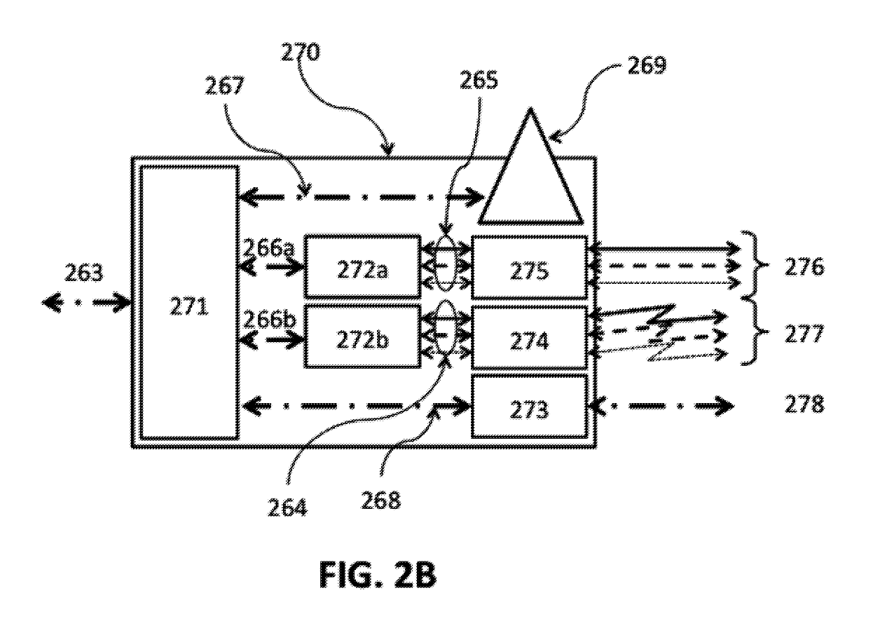

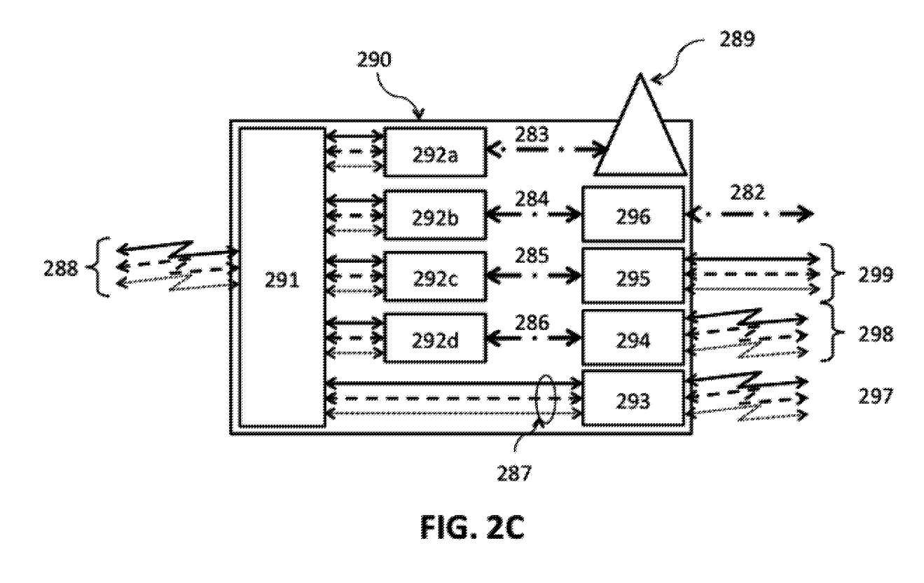

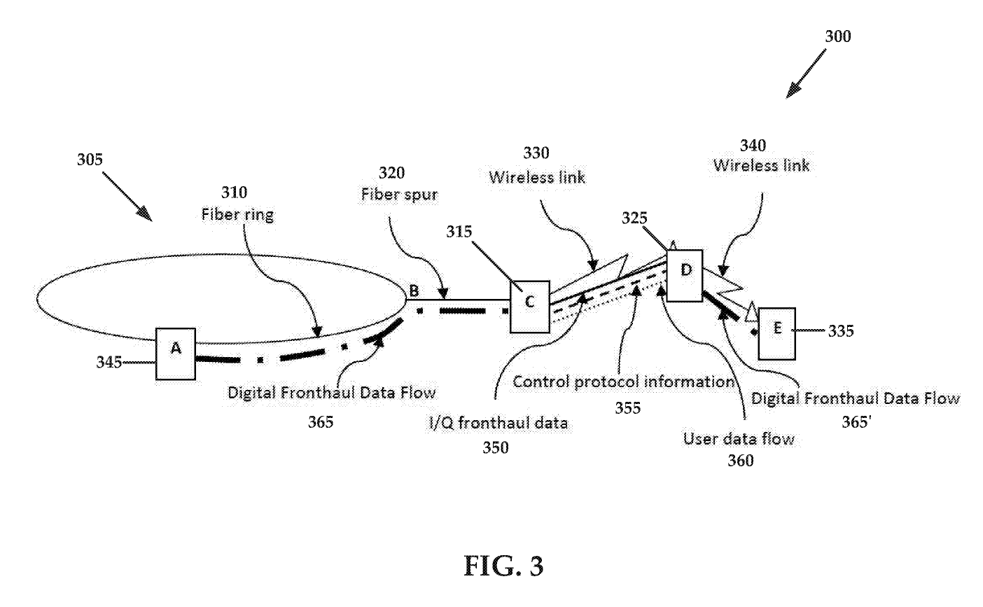

FIG. 1 illustrates an exemplary hybrid network 100 that includes a baseband module 105 associated with a wireline network 110. The wireline network 110 is shown as comprising a fiber ring 115 and a plurality of fiber spurs 120A-F. Additionally, a plurality of wireless networks are communicatively coupled with the fiber spurs 120A-F, as will be described in greater detail relative to FIGS. 2 and 3. It will be understood that the wireline network 110 may comprise any network that utilizes a wired rather than a wireless media. Exemplary wireline networks comprise but are not limited to fiber networks, copper wire networks, coaxial wire networks, and the like.

The hybrid network 100 may also comprise a network management system 125 and a core network 130, which in some instances includes, for example, a core cellular network.

Generally, the hybrid network 100 may be built on a variety of topologies to carry mobile network “fronthaul” signals (for example I/Q quantized samples), control and management protocol elements, and user digital data. Again, the hybrid network 100 may comprise any combination of different media including, but not limited to, fiber optic, electric cables and wireless links—just to name a few. The hybrid network 100 may comprise a transport network spanning one or more network segments that are communicatively coupled to the baseband module 105. The baseband module 105 may be communicatively coupled to any other portion of the hybrid network 100 via fronthaul data flow. It will be understood that the hybrid network 100 may include a limitless number of network segments which are connected to a centralized baseband processing server pool. The hybrid network 100 may support a hierarchical structure for connecting macro sites with stringent key performance indicators (“KPIs”, such as transmit power, receiver sensitivity, capacity, availability and range) and high capacity, down to small cell sites with relatively less stringent KPIs since they are designed to serve fewer users over a more geographically limited area.

The present technology provides flexibility for network operators to deploy coverage and capacity where it is needed most (e.g., based upon an RF propagation perspective) by providing both a wireless and a wired interconnection between one or more remote radio transceivers and one or more centrally located baseband modules.

In addition, these exemplary hybrid networks allow for the use of collaborative baseband processes such as joint processing and cooperative reception and transmission that allow for the potential for interference reduction and performance enhancement in a mobile network. Additionally, the hybrid networks allow for a wide range of topological options, including hub and spokes, daisy-chaining, and loops—just to name a few.

FIG. 2A illustrates a portion of an exemplary wide area transport network 200 that includes a wired network 205 that includes a fiber ring 210 which is communicatively coupled with a first wireless transceiver 215 via a fiber spur 220. Baseband module 245 transmits and receives all the fronthaul signals destined to or transmitted from mobile wireless transceivers 215, 225 and 235. The first wireless transceiver 215 uses the fronthaul signals from baseband module 245 and processed by fronthaul management module 214 and performs all the functions of a standard wireless transceiver. The first fronthaul management module 214 may also be communicatively coupled with a second (or more) fronthaul management module 224, coupled with a mobile wireless transceiver 225, via a first wireless fronthaul network segment 230. Fronthaul management module 214 forwards the portion of the fronthaul signals relevant to the other mobile wireless transceivers such as 225 and 235, to the fronthaul management module 224, in this case via a wireless link. The second wireless fronthaul transceiver 224 may also be communicatively coupled with a wireless fronthaul receiver 234 (e.g., endpoint) via a second wireless fronthaul network segment 240 and a mobile wireless transceiver 235. It will be understood that the mobile wireless transceiver 235 may include, for example, a wireless router or hub although one of ordinary skill in the art will appreciate that the mobile wireless transceiver 235 may comprise any wireless device that is capable of receiving and/or transmitting data over a wired or wireless network with the RF performance as required to handle the characteristics of the signals being transmitted.

It will be understood that the terms “mobile wireless transceiver” may include a network element that transmits and receives RF signals to and from the mobile users. The term “fronthaul module” may refer to a network element responsible for processing the fronthaul signals or data streams. Processing may include tasks such as coding/decoding, modulating/demodulating, multiplexing/demultiplexing, and so forth. In some instances, the mobile wireless transceiver and the fronthaul module may be combined together. Also, while the fronthaul module may be associated with wireless transmission equipment, the fronthaul module may also be associated with a wireline medium, or a mixed wireline/wireless medium. Thus the use of the term fronthaul module to refer to a fronthaul processing and transmission element.

In this embodiment, the network 200 is shown as comprising a baseband module 245 shown as being associated with the fiber ring 210. The hybrid network 200 is provided to efficiently transmit information from the baseband module 245 to mobile wireless transceivers 215, 225 and 235.

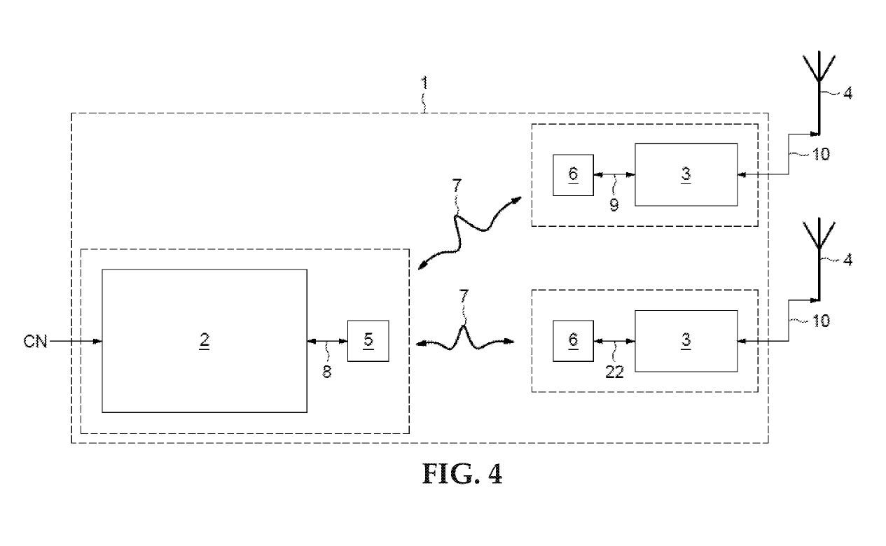

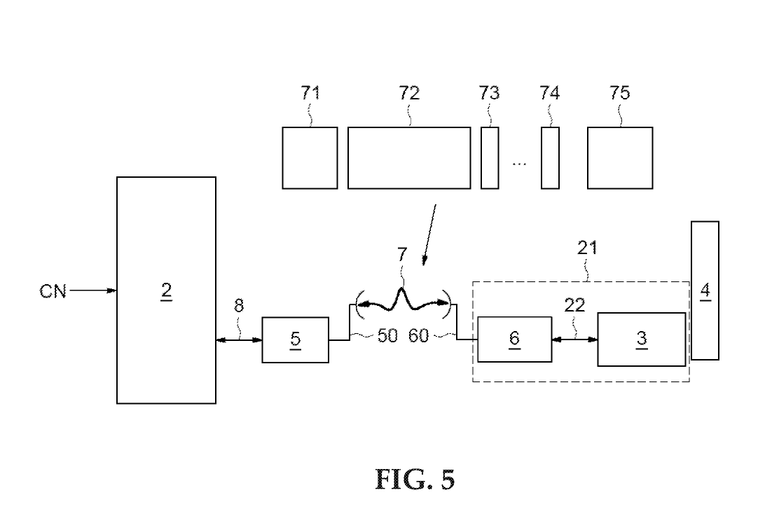

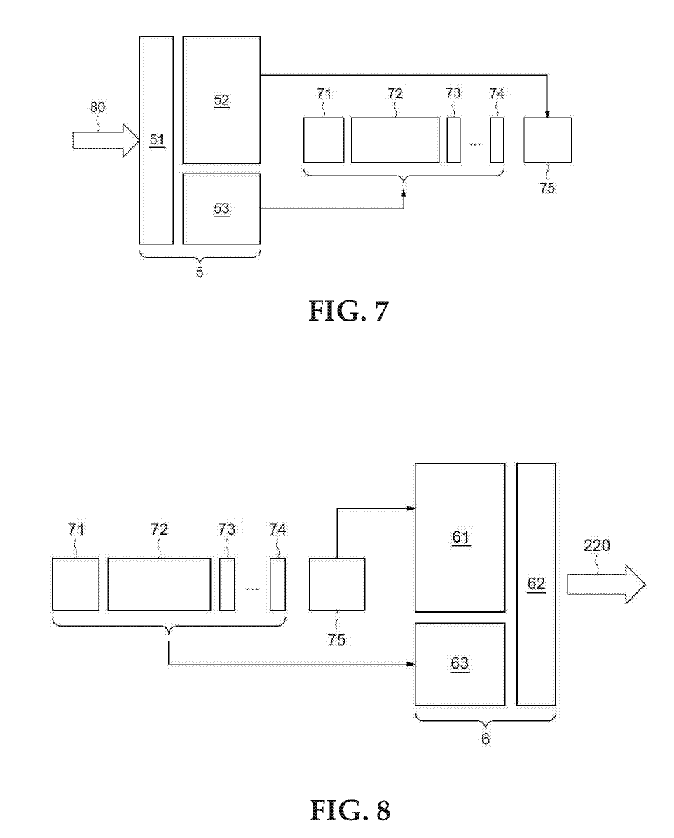

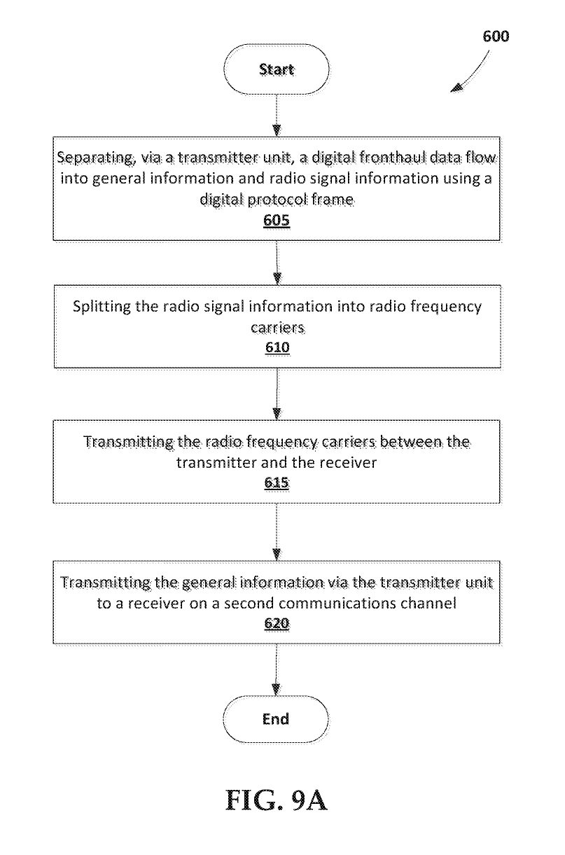

In accordance with the present technology, digital fronthaul data may be separated into constituent parts at the baseband module 245, in a manner that is described in greater detail relative to FIGS. 4-9B. Generally, the digital fronthaul data may be separated into radio signal information 250; control and protocol data 255; and user data 260. Each of the segments of the hybrid network, including both wired segments (e.g., the fiber ring and fiber spur), and the wireless network segments (e.g., first and second wireless network segments 230 and 240) are configured to transmit the separate parts of the digital fronthaul data flow. Thus, the first and second wireless transceivers 215 and 225 pass the separated data. Therefore, there is no need to demultiplex the digital fronthaul data as it travels along the hybrid network 200.

FIG. 2B illustrates an exemplary functional implementation of a fronthaul module 270 according to the present technology. Fronthaul module 270 presents a digital interface 263 using for example a fiber optic medium. The traffic on fronthaul interface 263 comprises a multiplexed signal that includes several fronthaul signals which are transmitted between a baseband module and a plurality of mobile wireless transceivers, which are communicatively coupled together via the wide area radio access network. An exemplary mobile wireless transceiver is represented as 269. Interface processing module 271 demultiplexes and multiplexes two or more of the fronthaul signals (e.g., fronthaul signals 266a, 266b, 267 and 268) according to a predefined multiplexing algorithm. Fronthaul signals may contain the fronthaul information for the subset of mobile wireless transceivers for which they are destined. Fronthaul signal 266a is fed into processing unit 272a which decomposes fronthaul signal 266a into a RF carriers signal built from the I/Q data contained within fronthaul signal 266a, digitally modulated general control data and digitally modulated user information, both contained in the fronthaul signal 266a, and altogether multiplexed into signal 265. A similar process applies to 266b through 272b and producing signal 264. Fronthaul signal 267 is transmitted into mobile wireless transceiver 269 which may be integrated inside the fronthaul module 270 or communicatively coupled with fronthaul module through an interface.

Multiplexed signal 265 is fed into interface module 275, which may use a wireline medium 276 comprising of any of fiber optic, coaxial cable or copper line. Multiplexed signal 264 may be fed into interface module 274, which may use a wireless medium 277. Interface module 274 can be implemented as a radio transceiver and antenna with the appropriate performance for transmitting multiplexed signal 264 over a certain distance. Fronthaul signal 268 is fed into a digital interface module 273 that may utilize a high capacity wireline medium 278. The signal transiting on this interface consists of the relevant fronthaul information to provide fronthaul signals to mobile wireless transceivers for which they are destined.

While the above represents one direction of the signal flows, all interfaces and modules are designed to process bidirectional signals, such that each operation has its symmetrical function for handling traffic in the other direction.

FIG. 3 illustrates a portion of an exemplary wide area transport network 300 that includes a wired network 305 that includes a fiber ring 310 which is communicatively coupled with a first fronthaul module via a fiber spur 320. The first wireless transceiver 315 may also be communicatively coupled with a second (or more) wireless fronthaul transceiver 325 via a first wireless fronthaul network segment 330. The second wireless fronthaul transceiver 325 may also be communicatively coupled with a mobile wireless receiver 335 (e.g., endpoint) via a second wireless network segment 340. It will be understood that the wireless receiver 335 may include, for example, a wireless router or hub although one of ordinary skill in the art will appreciate that the wireless receiver 335 may comprise any wireless device that is capable of receiving and/or transmitting data over a wired or wireless network.

In this embodiment, the network 300 is shown as comprising a baseband module 345 (also referred to as a baseband processor and/or a baseband module processing unit) shown as being associated with the wired network 305. The hybrid network 300 is provided to efficiently transmit information from the baseband module 345 to mobile wireless transceivers 315, 325 and 335.

While the embodiments described above contemplate the use of a fiber ring in combination with one or more fiber spurs, the use of a fronthaul module 270, which is communicatively coupled with the wireline network (e.g., the fiber ring) allows for the elimination of the need to utilize fiber spurs. That is, the fronthaul module 270 may communicatively couple with the wireless transceivers of the wireless network over a wireless communications path.

FIG. 2C illustrates another exemplary fronthaul module constructed in accordance with the present technology. In this case fronthaul module 290 uses a wireless interface 288 to receive data received from the baseband module located within the Wide Area Radio Access Network (e.g., wireless network) and to transmit data received from one or more mobile wireless transceivers, to the baseband module. The signals on this wireless interface may comprise a multiplex of modulated RF carriers, digitally modulated general control signals and digitally modulated user information.

Interface module 291 includes a wireless transceiver to process the wireless signals and to demultiplex the aggregated fronthaul signals into individual fronthaul signals which are transmitted fronthaul processing modules 292a, 292b, 292c and 292d, as well as into interface module 293. It is noteworthy that two types of multiplexing may occur: (1) multiplexing several fronthaul signals destined to multiple Remote Radio Units (RRU sometimes referred to as Remote Radio Heads or RRH) (mobile wireless transceivers); and (2) multiplexing the RF carriers with the control information and with the user information for each individual fronthaul signal, as well as to multiplex fronthaul signals from the mobile wireless transceivers which are destined for the baseband module (reverse operation). The purpose of 292a, 292b, 292c and 292d is to transform the digital fronthaul signal into a multiplex of radio carriers, digitally modulated control and digitally modulated user information, resulting in digital fronthaul signals 283, 284 285 and 286, respectively.

In the present example, digital fronthaul signal 283 is transmitted to mobile wireless transceiver 289, which is equipped with a digital wireless fronthaul interface. One example of such interface is given by the Common Public Radio Interface standard or CPRI and the corresponding systems are sometimes referred to as Remote Radio Heads (RRH) or Remote Radio Units (RRU). Conversely digital fronthaul signal 283 is also used to carry uplink signals from the mobile wireless transceiver 289 and destined for the baseband module. In this case, the digital fronthaul signal may only contain the fronthaul signal relevant to mobile wireless transceiver 289.

In the present example, digital fronthaul signal 284 is provided to digital fronthaul interface unit 296 which provides an external digital fronthaul signal 282 used to transmit and receive fronthaul information relevant to the mobile wireless transceivers located in the corresponding part of the network (i.e., “behind” this port). In this case, digital fronthaul signal 282 may contain the fronthaul signal relevant to those mobile wireless transceivers. As an example, digital fronthaul signal 282 may use a fiber medium with a high capacity.

In another example, digital fronthaul signal 285 is transmitted to fronthaul interface unit 295 which provides fronthaul interface 299 used to transmit and receive fronthaul information relevant to the mobile wireless transceivers located in the corresponding part of the network (i.e. “behind” this port). In this case fronthaul signal 299 comprises a multiplex of RF carriers, digitally modulated control information and digitally modulated user information carried over a wireline medium. In this case, fronthaul signal 299 may only contain the fronthaul signal relevant to those mobile wireless transceivers. As an example, fronthaul interface 299 may use a fiber medium (or a wavelength of a fiber) or a coaxial cable medium. (In the present example, digital fronthaul signal 286 is used to feed wireless fronthaul interface unit 294 which provides fronthaul signal 298 used to transmit and receive fronthaul information relevant to the mobile wireless transceivers located in the corresponding part of the network (i.e., “behind” this port). In this case fronthaul signal 298 comprises a multiplex of RF carriers, digitally modulated control information and digitally modulated user information carried over a wireless medium. In this case, wireless fronthaul signal 298 may contain the fronthaul signal relevant to those mobile wireless transceivers. As an example, wireless fronthaul interface 299 may comprise an appropriately engineered RF transceiver and antenna.

In the present example, fronthaul signal 287 is a multiplex of RF carriers, digitally modulated control information and digitally modulated user information carried between interface module 291 and wireless interface module 293. Wireless interface module 293 may comprise an appropriately engineered RF transceiver and antenna. In this case, wireless fronthaul signal 287 and wireless fronthaul signal 297 may comprise the fronthaul signal relevant to those mobile wireless transceivers located in the corresponding part of the network. In this case, no conversion to digital fronthaul format is required.

With regards to FIG. 3, and in contrast with the hybrid network 200 of FIG. 2A, the first wireless transceiver 315 is configured to separate a digital fronthaul data received from the baseband module 345 into constituent parts such as radio signal 350, control and protocol information 355, and user data information 360. Conceptually, when an evaluation of key performance indicators for a wireless network segment, such as the first wireless fronthaul network segment 330 indicate that transmission of the digital fronthaul data 365 would be impractical or impossible via the first wireless network segment 330, the first fronthaul management module may separate the digital fronthaul data into the various parts described in greater detail relative to FIGS. 4-9B. For example, if the available bandwidth of the first wireless network segment 330 is less than the size of the digital fronthaul data, the digital fronthaul data may be split and then transmitted over the first wireless network segment 330.

In some instances, the second fronthaul management module 324 may pass the separated information to the fronthaul management module 334 associated with wireless receiver 335. According to some embodiments, the second wireless transceiver 325 may recreate digital fronthaul data 365′ from the separate information before transmitting the recreated digital fronthaul data 365′ to the wireless receiver 335. Again, methods for recreating the digital fronthaul data from separated information are described in greater detail relative to FIGS. 4-9B. Also, the recreated digital fronthaul data 365′ may include different data relative to the original digital fronthaul data 365 because in some embodiments, unneeded data may be removed or modified during separation of the original digital fronthaul data 365.

FIG. 4 illustrates an exemplary method 400 for transmitting data over a wide area transport network. Again, this network includes a hybrid network that comprises at least one wired network segment and at least one wireless network segment that are communicatively coupled to one another. The hybrid network allows for efficient transmission of data between a transmitter and a receiver, such as a baseband module and a radio frequency unit, respectively.

FIGS. 4-9B collectively illustrate systems and methods for providing for high capacity wireless communications between one or more base band units (“BBU”) and one or more radio frequency units (“RFU”) within a wireless network assembly, such as a base station (“BS”). The BBU and RFU communicate digitally with one another through a bidirectional transport interface. Signals representing carrier data may be transmitted and received by the antenna(s) associated with the base station (BS) may be sent in the manner known as “I/Q,” which stands for “in phase/in quadrature.” Other information that does not represent carrier data may also be communicated between the BBU and RFU. These two types of information are typically multiplexed into a digital fronthaul data.

More specifically, the BBU and the RFU may be communicatively coupled using a standardized/approved open protocol, a proprietary protocol, or a combination thereof. In some embodiments, protocols utilized between the BBU and RFU facilitate bidirectional transmission of the digital fronthaul data between the BBU and the RFU either by fiber optics or other wired coupling types. Again, these protocols allow for time-division multiplexing various types of the information such as general information, which may include, but is not limited to control, command, synchronization, and other data, other than “I/Q” information. Radio signals comprising carrier data, also referred to as “traffic data” or “I/Q data,” may be transmitted and received by various antenna(s) associated with the Base Station.

These protocols may be entirely digital in nature and their throughput are generally in excess of 600 megabits/s and can exceed 10 gigabits/s. The structure of these protocols typically includes a set amount of words that represent general information and a set amount of words that represent the I/Q data. In some instances the set amount of words representing the general information may be relatively smaller than the set amount of words that represent the I/Q data.

Normally, in order to transport both the I/Q data and the general information, the I/Q data (e.g., radio signal information) is transmitted as a whole in digital form. Digital streams and/or multiplexes may be handled by the system at gradually increasing throughput rates. For example, digital streams on the order of approximately tens of gigabits/s may be transmitted using radio access technologies such as 3G/4G, LTE “Long Term Evolution”, LTE-Advanced, and so forth.

Because of its almost limitless capacity, fiber optic media may be utilized to transmit I/Q data. Other solutions contemplate transmitting the digital I/Q and/or general data using wireless networks. One solution contemplates the use of radio waves. This solution requires a substantial throughput rate in order to transport the entire structure (e.g., both I/Q and general data), and thus, substantial bandwidth utilization or sophisticated modulation may be required. These exemplary methods are described in greater detail in European Patent Number 1534027. Another solution contemplates the use of optical waves, as indicated in document U.S. Patent Application Publication Number 2003-027597. While both of these wireless systems propose a digital solution for connecting the BBU module to the RFU radio, these systems suffer from drawbacks which include, but are not limited to the fact that the throughput (e.g., fronthaul) of these systems is quite substantial.

Advantageously, the present technology allows for the transmission of information using wireless systems in such a way that a substantial reduction in the size of the throughput between the BBU and the RFU is achieved while ensuring complete transmission of I/Q data, which is constantly evolving and growing over time. These and other advantages of the present technology will be described in greater detail below with reference to the drawings.

Referring now to FIG. 4, which illustrates an exemplary architecture for practicing aspects of the present technology. A base station (BS) 1 is shown as comprising a baseband module (BBU) 2, which is communicatively coupled with the core network (CN). The CN manages communicative coupling with a public telephony (PSTN) or data network. BBU 2 may be communicatively coupled with a connection unit BBU 5 via any suitable path or channel that allows for the transmission of digital data.

The BS 1 may also comprise a series of radio frequency units, such as radio frequency unit (RFU) 3a and 3b. In this example, two RFUs are present. In one instance, RFU 3a may be communicatively coupled with a RFU coupling module 6a by a communications channel 9 which may allow for analog or mixed analog and digital transmission. In the other instance, RFU3b may be communicatively coupled to a RFU coupling module 6b by a digital communications channel 22. In an embodiment, RFU 3a may be communicatively coupled to an antenna 4a by a second communication path 10a and RFU 3b may be communicatively coupled to an antenna 4b by a second communication path 10b. The BBU coupling module 5 additionally communicates with all RFU coupling modules 6a and 6b via a wireless communications channel 7a or 7b, also referred to as a “wireless network segment.”

FIGS. 4, 5, 7, and 6 collectively illustrate an exemplary system and method for transmitting information using the system of FIG. 4. According to some embodiments, the BBU 2 may be communicatively coupled with the core network (CN) according to methods that would be known to one of ordinary skill in the art with the present disclosure before them.

The BBU 2 communicates with at least one of the RFUs 3 using the BBU coupling module 5, to which the BBU 2 is communicatively coupled via a digital communications channel 8. While the BBU coupling module 5 and BBU 2 have been shown as being separate devices, in some instances the BBU coupling module 5 and the BBU 2 may be integrated into the same device. In some embodiments digital protocol frames 80 may be transmitted between the BBU 2 and an RFU 3 via BBU coupling module 5 using the digital communications channel 8. It is noteworthy that a digital protocol frame 80 may comprise a series of words related to information of two types: (a) words corresponding to general information; and (b) words corresponding to “I/Q” radio signal information. While the method contemplates the use of “words” to differentiate between the two basic types of information included in the digital fronthaul data, the system may be configured to differentiate information types using any other differentiators that may also be used in accordance with the present technology.

Generally, a method for transmitting information may comprise separating digital fronthaul data into the two basic data types, comprising I/Q data and general data. In some instances, separating digital fronthaul data may include demultiplexing of the digital fronthaul data by evaluating digital protocol frames 80.

In another embodiment, a method for transmitting information may comprise separating analog RF signals and the general data, and transmitting them on two different channels.

The digital protocol frames may be evaluated to differentiate words related to general information from the words related to IQ radio signal information in each of the digital protocol frames 80.

Again, data included in the digital protocol frames 80 may be demultiplexed in a demultiplexing module 51 in the BBU coupling module 5. The BBU coupling module 5 may then transmit the demultiplexed information types via the wireless communications channel 7 using an antenna 50. More specifically, the digital protocol frames 80 may be separated into general information and radio frequency information. The general information may be extracted from the protocol frames 80 by the demultiplexing module 51 and passed through as digitally modulated data by digital modulator module 52. The radio frequency information may be further separated into information constituting radio frequency carrier signals 71-74, also referred to as carrier images and modulated accordingly into radio frequency carriers 71-74 by module 53.

Words related to general information may be transmitted through a digital communication channel of the wireless communications channel 7 using digital modulation. With regard to the I/Q radio signals, it should be noted that the I/Q radio signals ultimately represent carriers intended for transmission or reception by the antenna(s) 4 associated with the base station 1. The base station 1 may process the I/Q radio signals with the appropriate technologies required by the radio access interfaces (Radio Access Technology or “RAT”), which allows for communication between mobile devices and the antennas 4 of the BS 1.

Next, the BBU coupling module 5 may be configured to separate the words related to IQ radio signals into a series of radio frequency carriers. The information belonging to I/Q radio signals contained in the digital protocol frame 80 are transmitted as radio frequency carriers 71, 72, 73, 74 by the BBU coupling module 5 through the wireless communications channel 7.

It will be understood that the transmission of I/Q radio signals used by the wireless communications channel 7 may be based on similar radio access technologies implemented by the one or more RFU 3 for the carriers and RAT in question, transmitted and received by the antennas 4 and associated with the RFU 3. For example, the radio technology used to transmit the I/Q radio signals may enhance the efficiency of data transmission over the wireless communications channel 7 relative to various performance characteristics of the wireless medium. These performance characteristics include, but are not limited to line of sight propagation, point-to-point topology, lower interference, and so forth.

The words related to I/Q radio signals are converted into radio frequency carriers 71, 72, 73, 74 using techniques that would be known to one of ordinary skill in the art such as filtering, digital up conversion “DUC”, I/Q mixing, mixing, digital/analog conversion, and so forth.

Advantageously, transmitting I/Q radio signals in the form of radio frequency carriers may be transparent at the throughput rates proposed by RATs of operators of the BS 1, as the integrity of the I/Q radio signals, carrier “images”, and RATs, transmitted and received by the antennas 4 is sufficiently maintained with regard to the overall performance of the wireless communications channel 7. In some instances, transmitting I/Q radio signals in the form of radio frequency carriers may be accomplished in a non-transparent manner.

Moreover, the bandwidth necessary for the wireless communications channel 7 may be as defined by the associated RAT(s), which are transmitted and received by the antennas 4 associated with the RFU 3.

As an end result, a series of radio frequency carriers 71, 72, 73, 74 for each digital protocol frame 80 may be transmitted through the wireless communications channel 7, and one or more digital modulations may be utilized to transmit the general information protocol elements. The series of radio frequency carriers 71, 72, 73, 74 and the digitally modulated transmissions 75 are then received by the RFU coupling module 6 using an antenna 60.

Next, the RFU coupling unit 6b may perform a method of reassembling the fronthaul signals and data from the previously separated data (e.g., I/Q radio signals and general information). An exemplary method for transmitting information may further comprise converting the series of radio frequency carriers 71, 72, 73, 74 into a series of words representing the I/Q radio signal information. Again, techniques that would be known to one or ordinary skill in the art may be utilized, such as filtering, digital down conversion “DDC”, I/Q mixing, mixing, digital/analog conversion and so forth. The digitally modulated transmissions 75 may be used by the RFU 3b according to a pre-established protocol.

More specifically, the method may include conversion by conversion unit 63 of the series of radio frequency carriers 71, 72, 73, 74 into a series of words representing the content of the I/Q radio signals, and demodulation of the digitally modulated data into words representing the general information 61. The series of words may be multiplexed by reassembling the words to recreate digital protocol frames 220, which correspond to the digital protocol frames 80 which were previously demultiplexed. The digital protocol frames 220 are then transmitted to the RFU 3b through second communications channel 22. The second communications channel 22 may allow for the transmission of digital and/or analog data.

In some instances, the carrier images 71-74 may be multiplexed into radio signal information 63, while modulated transmissions 75 is demodulated back into the general information 61. The general information and radio signal information 63 may be reassembled back into digital fronthaul data 62, which is transmitted as digital protocol frames 220.

In order to ensure proper reconstruction of the digital protocol frames 220, synchronization information is transmitted between the BBU coupling module 5 and the RFU coupling module 6b to allow the general information and the I/Q radio signal information of the digital protocol frames 220 to be returned to a coherent form.

The digital protocol generally used to transport frames 80 (after demultiplexing), 220 (after multiplexing) allow for substantial distances between the BBU and the RFU. Therefore those protocols can tolerate a significant proportional delay whether on a wired or a wireless link. For example, for each 10 kilometers of fiber optic used, a delay of 55 microseconds may be seen. Additionally, it is possible to temporarily store the general information or the I/Q information in a buffer zone within the RFU coupling module 6b. This allows for more coherent processing of all (or a substantial portion) of information received based on synchronization information, by the RFU coupling module 6b.

In another exemplary embodiment information not useful to the digital protocol frame 80 is removed in order to eliminate useless information. For example, words that are not filled or used may be eliminated. Thus, only necessary information may be transmitted, proportionally reducing the volume of information transmitted.

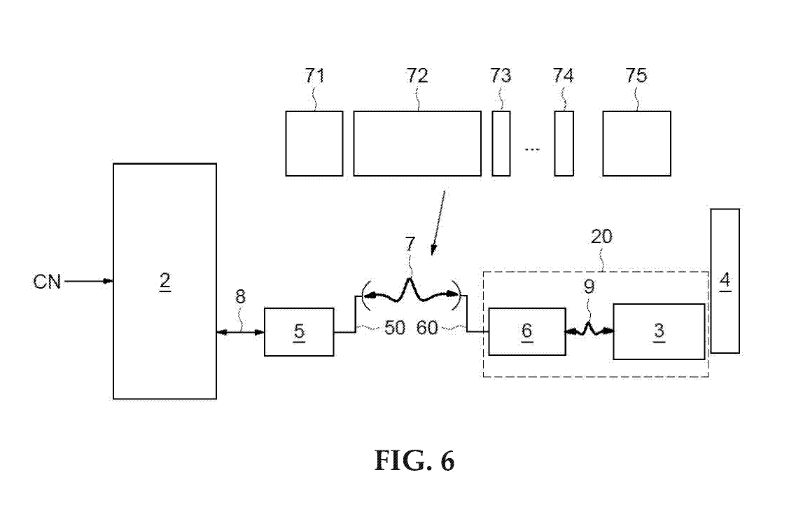

FIG. 6 illustrates another exemplary embodiment where the RFU coupling module 6a and the RFU 3a form a wireless remote radio head (RRH). According to some embodiments, the RFU coupling module 6a retransmits to the RFU the radio frequency carriers 71, 72, 73, 74 via first communications channel 9, for retransmission via the antenna 4a associated with the RFU 3a. According to some embodiments, the RFU coupling module 6a may not multiplex the general information words and in some instances it may not convert the radio frequency carriers 71, 72, 73, 74 into words related to the I/Q radio signal information. Accordingly, the aforementioned digital protocol frames 220 may not be reconstructed by the RFU coupling module 6b. Alternatively, the RFU coupling module 6b may adapt the radio frequency carriers 71, 72, 73, 74 based on the associated RATs for transmission by the relay antenna 4b associated with the RFU 3b.

In some instances the general information may be processed by the RFU coupling module 6 (e.g., instead of being transmitted to 3 which then uses it to perform control or management tasks). In some instances, in addition to the first communications channel 9, which may comprise an analog communication link, there may be a separate control interface (such as an API) over which a control and management process can take place.

The term “processing” may be understood to include the modification of RF signals based upon the content control information included in the general information.

According to some embodiments, a BBU coupling module 6a may be used to interpret and utilize the general information in order to perform various actions, such as actions performed by the RFU 3a with regard to the same type of information. Thus, it may no longer be necessary to transmit complete general information to the RFU 3a, which may result in a reduction in the amount of information from the digital protocol frame, leading to more efficient data transmission.

It should be noted that in an exemplary operation, data may be transmitted between the BBU 2, serving as a transmitter, to one of the RFUs 3, serving as a receiver. However, data may likewise be transmitted between one of the RFUs 3, in this case serving as a transmitter, to the BBU 2, which in this case would serve as a receiver.

Advantageously, the present technology may allow for processing of radio frequency carriers in terms of bandwidth (MHz/bandwidth) rather than in terms of throughput rate (Mbit/s) via the wireless communications channel 7. Again, the wireless communications channel 7 may communicatively couple the BBU 2 and the series of RFUs 3 of the BS 1. This configuration allows for a digital solution that benefits from the modulation effectiveness of the technologies implemented on this wireless communications channel 7.

Additionally, spectrum efficiency may be maintained transparently with regards to the Radio Access Technology used on wireless communication channel 7. The present technology can also benefit from the inherent advantages of line of sight/non-line of sight “LoS/NLoS” technologies between fixed stations and single users. Additionally, this method allows the use of different frequency bands to transmit different signals according to the methods described in European Patent Number 1895681, which is hereby incorporated by reference herein in its entirety including all references cited therein.

In some instances the present technology advantageously accommodates complementary diversity technologies to increase efficiency such as multi-polarization, line-of-sight multiple-input multiple-output “LoS MIMO,” and so forth.

With methods and systems for transmitting information described above relate to the field of mobile telephony, the present technology may be applicable to many types of radio networks such as public mobile radio networks “PMR” used by law enforcement and first responders, as well as in any radio system that includes radio stations and antennas or active antennas and/or radar—just to name a few.

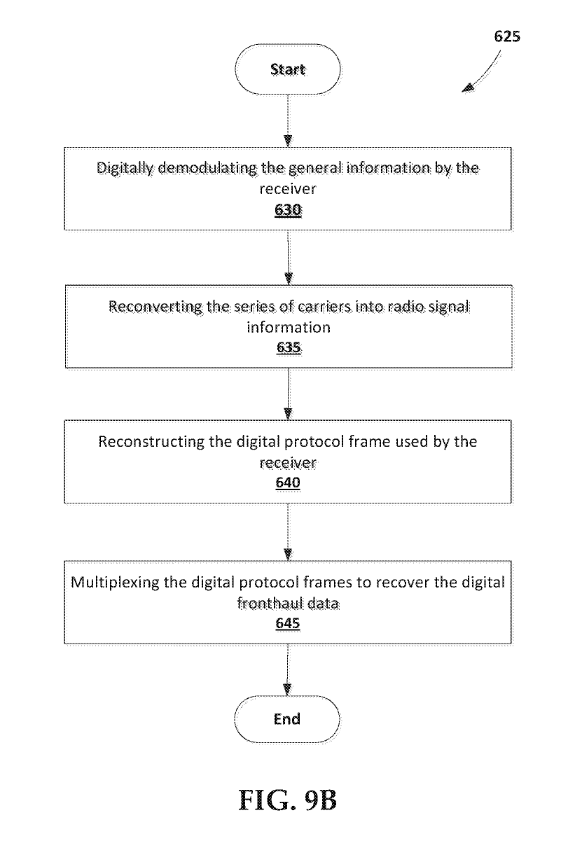

FIG. 9A is a flowchart of an exemplary method 600 for transmitting information via a wireless communications channel. According to some embodiments, the method 600 may comprise a step 605 of separating, via a transmitter unit, a digital fronthaul data flow into general information and radio signal information using a digital protocol frame. According to some embodiments, the step 605 of separating may include demultiplexing of the general information and the radio signal information from the digital fronthaul data.

In some instances, in the step 605 of separating, information not belonging to the digital protocol frame may be removed to reduce the amount of unneeded data that is transmitted over the wireless network segment. This feature may reduce the latency of the wireless network segment, while also reserving network bandwidth for greater consumption and transmission of radio signal information and/or general information.

Additionally, the method 600 may comprise a step 610 of splitting the radio signal information into radio frequency carriers as well as a step 615 of transmitting the radio frequency carriers between the transmitter and the receiver. The transmission of the radio signal information and/or carrier is carried out using appropriate radio access interface technologies. Moreover, step 620 may include a step of transmitting the general information via the transmitter unit to a receiver on a second communications channel. In some instances, the transmitter and the receiver may be communicatively coupled with one another using a digital communications channel. In some instances, the general information may be transmitted over the wireless network segment by digital modulation of the general information.

FIG. 9B is a flowchart of an exemplary method 625 for transmitting information. It is noteworthy that the method described with regard to FIG. 9A specifies the separating of digital fronthaul data into constituent parts to enhance the transmission of the constituent parts over a wireless network segment. The method 625 of FIG. 9B contemplates the reassembling of the separated parts transmitted over the wireless network segment in such a way that the digital fronthaul data is recreated.

The method 625 may include a step 630 of digitally demodulating the general information as it is received by the receiver (or prior to receipt of the general information). Similarly, the method 625 may include a step 635 of reconverting the series of carriers into radio signal information. Again, the radio signal information is a digital signal. By extension, the step 635 allows for a step 640 of reconstructing the digital protocol frames used by the receiver. After reconstructing the digital protocol frames, the method may include a step 645 of multiplexing the digital protocol frames to recover the digital fronthaul data. It is noteworthy that the recovered digital fronthaul data may include less data than the original digital fronthaul data if unneeded data was removed during a subsequent step of evaluating the digital protocol frames.

Although not shown, exemplary methods may also include steps such as transmitting information for synchronizing the general information and the radio signal information as well as buffering of both the general information and the radio frequency information before synchronizing the general information and the radio signal information. This synchronization may depend, in part, on the synchronization information used. Synchronization may be utilized for timing recovery, location determination using methods such as Time Difference of Arrival, and various mobile wireless functions such as diversity, Multiple Input Multiple Output, coordinated or joint transmission, and time division multiplexing. For example, transmission of the general information and the radio frequency information through the wireless network having unstable synchronization may result in a degradation or failure of the mobile wireless performance. This problem is propounded when several fronthaul links are chained or juxtaposed. Thus, proper and stable synchronization of the various nodes in the transport network is necessary to ensure a proper quality and performance. It is noteworthy that transmission steps may be carried out on different frequency bands. Additionally, in some embodiments the transmitter may include a baseband module and the receiver may include at least one radio frequency unit, or vice versa.

Other exemplary methods may include the step of processing the general information in the BBU coupling module 5 prior transmitting it. The term “processing” may be understood to include the modification of RF signals based upon the content control information included in the general information.

According to some embodiments, obtaining precise and stable synchronization may be realized by using global positioning system (GPS) data obtained from receivers communicatively coupled with certain fronthaul management modules within the network. Since a high precision of the synchronization information may not be required in all nodes of the network, using additional synchronization sources such as GPS can be used in those nodes where such precision may be required. By using this external synchronization source, the fronthaul modules are able to ensure that the synchronization information stays precise over any period of time. While the use of GPS data has been described, one of ordinary skill in the art would appreciate that other synchronization data may likewise be utilized in accordance with the present technology.

As mentioned previously, while the above-described methods for transmitting information have been described in relation to a base station (BS) of a mobile telephone communications system, the methods for transmitting information are applicable in any suitable field that would be known to one of ordinary skill in the art with the present disclosure before them.

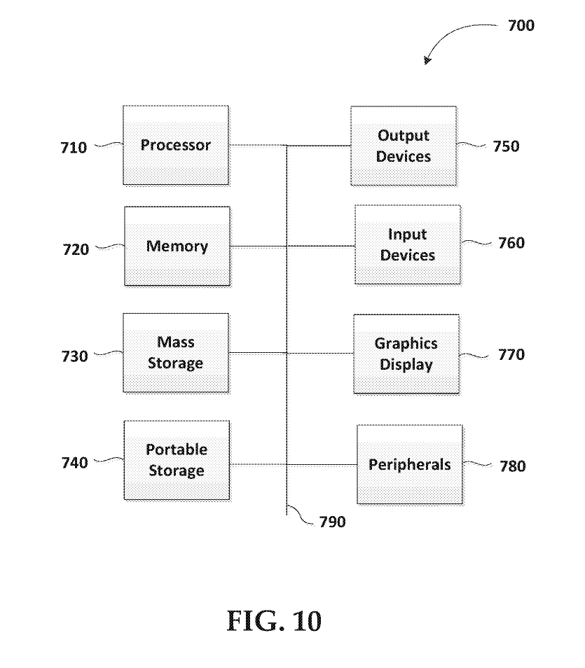

FIG. 10 illustrates an exemplary computing system 700 that may be used to implement an embodiment of the present technology. The computing system 700 of FIG. 10 includes one or more processors 710 and memory 720. Main memory 720 stores, in part, instructions and data for execution by processor 710. Main memory 720 can store the executable code when the system 700 is in operation. The system 700 of FIG. 10 may further include a mass storage device 730, portable storage medium drive(s) 740, output devices 750, user input devices 760, a graphics display 770, and other peripheral devices 780. The system 700 may also comprise network storage 745.

The components shown in FIG. 10 are depicted as being connected via a single bus 790. The components may be connected through one or more data transport means. Processor unit 710 and main memory 720 may be connected via a local microprocessor bus, and the mass storage device 730, peripheral device(s) 780, portable storage device 740, and graphics display 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present technology for purposes of loading that software into main memory 720.

Portable storage device 740 operates in conjunction with a portable non-volatile storage medium, such as a floppy disk, compact disk or digital video disc, to input and output data and code to and from the computing system 700 of FIG. 10. The system software for implementing embodiments of the present technology may be stored on such a portable medium and input to the computing system 700 via the portable storage device 740.

Input devices 760 provide a portion of a user interface. Input devices 760 may include an alphanumeric keypad, such as a keyboard, for inputting alphanumeric and other information, or a pointing device, such as a mouse, a trackball, stylus, or cursor direction keys. Additionally, the system 700 as shown in FIG. 10 includes output devices 750. Suitable output devices include speakers, printers, network interfaces, and monitors.

Graphics display 770 may include a liquid crystal display (LCD) or other suitable display device. Graphics display 770 receives textual and graphical information, and processes the information for output to the display device.

Peripherals 780 may include any type of computer support device to add additional functionality to the computing system. Peripheral device(s) 780 may include a modem or a router.

The components contained in the computing system 700 of FIG. 10 are those typically found in computing systems that may be suitable for use with embodiments of the present technology and are intended to represent a broad category of such computer components that are well known in the art. Thus, the computing system 700 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

According to some embodiments, the present disclosure is directed to efficiently transmit radio signals between a baseband unit and a plurality of remote radio transceiver devices. The systems and methods of the present disclosure function to centralize processing of digital communication signals at the baseband unit and allow the baseband unit to efficiently and effectively transmit its fronthaul data to the remote radio equipment devices efficiently through bandwidth optimization techniques, in some embodiments. The remote radio equipment devices can comprise small, lower power radio transceivers that are used to proliferate wireless communications to many users in a highly efficient and scalable manner.

For context, there is an ever increasing demand for wireless capacity and a limited, slowly increasing amount of wireless spectrum is driving a densification of cellular networks in order to deliver the required capacity (expressed in Mbps/MHz/sq km). For example, the use of M2M technologies, increased mobile device usage, and Internet of Things are examples of devices and applications that are driving this proliferation.

In a dense network of small cells (such as a contiguous pico-cellular network), an example architecture can involve centralized baseband processing and distributed radio transceivers. Centralizing the baseband processing and higher layers of communication protocols enables a more efficient and cost-effective multi-cellular network. It also provides more flexibility to provide advanced services and features through a concentration of the data processing and networking capabilities of the network. Importantly, such architectures enables virtualization of the baseband resources by enabling the physical separation of remote radio transceiver and the baseband processing and network management functions. Such architectures are exemplified in the Cloud RAN (C-RAN) or Virtual RAN architectures.

In contrast to a cellular network's use of backhaul, the architectures described in the present disclosure implement a fronthaul interface in order to link a centralized baseband processing unit and its processing capabilities with a plurality of distributed RF transceivers.

Traffic on the fronthaul interface comprises a representation of incoming and outgoing RF signals on any given mobile channel to and from any RF transceivers, plus control and management signals destined to manage the RF transceivers, as well as, possibly, other digital information such as user or application data destined to be transmitted to or from the mobile user using other means. The representation of the incoming and outgoing RF signal may be either in digital format (digitized IQ mobile carrier samples) or in analog format, as described in greater detail in the embodiments herein.

An example method for linking the baseband processing with the radio transceivers is to use dedicated fiber optic lines or multi Gbps millimeter backhaul systems to transmit the digital fronthaul data transparently, on a point to point basis.

A more cost effective and flexible method comprises utilizing a broader range of transmission media, including wireless transport, which is also described in greater detail herein.

Another cost effective solution is to use wireline telecommunication networks, whether they are fiber optic based or based on copper (twisted pair) or coaxial cables, or a mix of wireline and wireless media, using a method as described in greater detail herein.

A mix of wireline and wireless infrastructure may be advantageously used to produce a fronthaul network, using wireline or wireless resources depending on the need or the constraints (such as the availability of installed wireline transmission facilities, for example).

An example of a hybrid fronthaul network may be realized using fiber or wireless links and various transmission methods on this network, as described herein.

In a centralized RAN architecture, as the density of cell sites increases to meet the need for ever-increasing mobile traffic, so does the number of fronthaul links in a given area. Considering that a network of pico-cells at the scale of a city or a suburb is likely to require a high number of cell sites—for instance numbering in the hundreds per square kilometer—each with their RF transceiver equipment, a scalable method of connecting those RF transceivers to the centralized baseband is required.

Traditional point to point methods for linking centralized baseband and distributed radio transceivers may be limited in scalability, particularly in high density cellular environments. As an example, point-to-point wireless systems require both the installation of dedicated equipment and the use of dedicated spectrum resources for each link. For each additional link, it becomes necessary to choose new frequency resources in order to avoid interfering with the other installed wireless fronthaul links in the same general location. Therefore, deployment of those systems is limited once the available spectrum is saturated in a given geographical area, due to interference between the links. Thus, the scalability of such a system is limited.

In addition, the installation of a wireless point to point link requires a pair of equipment, one of the pair being installed at each end of the link, as well as alignment of the antennas on each side. Configuration between the aligned links is utilized order to achieve the best performance. Of particular importance to the quality of such a link is ensuring a low level of interference to enable a high quality of transmission and overall system performance. This process is usually labor intensive as it is performed on both sides of the link. Therefore, the installation cost of deploying such a network is high due to the inherent nature of a point to point link. For example, such a system would require twice the electrical power and would incur twice the leasing cost. The recurring operational cost is also increased by the need to maintain and operate the pair of equipment, and possibly due to the recurring point to point license fee.

The benefit of a point to multipoint system has been demonstrated for wireless access systems as well as for wireless backhaul systems. Various standard and proprietary systems have been developed and deployed, using a wireless or wireline topology. With such a system, connectivity may be achieved within the coverage area of the point to multipoint hub (or access point, or base station) by installing a terminal device. Therefore, point to multipoint systems decrease the total cost of a deploying and operating a network system thanks to streamlined installation processes and the ability to share a fixed amount of bandwidth between multiple users. While this method can be used for various types of voice or data traffic as well as for backhaul applications, the deployment of such solution for a fronthaul application is challenging due to the nature of the fronthaul signal.

For example, the fronthaul standards such as CPRI (Common Public Radio Interface), OBSAI (Open Base Station Architecture Initiative) or ORI (Open Radio equipment Interface) utilize a transmission capability offering a constant bit rate with a high bandwidth. Future protocol evolution (as in the upcoming 5G standards) will also involve similar capabilities for the fronthaul links. Typical fronthaul applications utilize today at least 2.5 Gbps per remote radio, and evolutions of mobile standards are pushing this requirement to beyond 10 Gbps in the near future.

Since fronthaul equipment (baseband units) is tasked with carrying radio frequency signals, among other data or signals, to and from remote radios and since those signals are often continuously transmitting, no efficiencies can be gained with the current fronthaul protocols (as mentioned above) through multiplexing of those signals. Considering the most efficient point to multipoint broadband systems currently offer a total in the few hundreds of Mbps, to be shared between numerous users, it is evident that those systems may not be used for fronthaul applications. Therefore capacities in the multiple of tens of Gbps are required to support point to multipoint transparent transport of digital fronthaul signals, a capacity outside the reaches of most technologies. In addition, the nature of fronthaul traffic requires exceedingly low latencies and high timing accuracies. Typical latency requirements are in the tens of microseconds, while timing accuracy is required to be less than a few 100 nanoseconds. By comparison, current point-to-multipoint systems, such as the systems used for backhaul, are characterized by latencies in the tens of milliseconds, therefore at least a thousand times higher. Additionally, considering the stringent timing and latency requirement, buffering options are severely limited as they would increase latency and reduce timing accuracy.

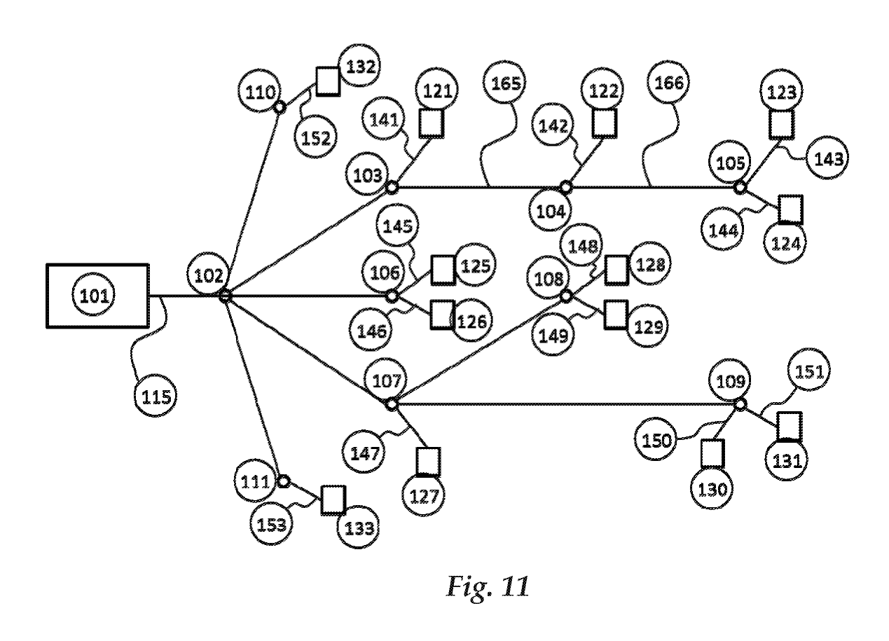

The systems and methods of the present disclosure (such as the embodiments of FIGS. 11-16) increase the capacity of the fronthaul network by enabling an efficient and flexible point to multipoint mode of operation that allows a centralized management of the wireless resources adapted to a fronthaul application. Such a system may be engineered to both increase the network capacity by removing the scalability limitations of the point to point system, and to offer a lower cost of deployment and operations. Installation cost may be reduced since a single unit of equipment can be utilized to implement each wireless fronthaul link. The systems and methods herein also allow for a more automated and dynamic use of resources, further increasing capacity and lowering operational costs.

FIG. 11 illustrates an example system 100. The system comprises a point to multipoint fronthaul system (hereinafter the “system 100”) that is configured to transport fronthaul signals between a centralized baseband unit 101, and several remote radio units such as 121, 122, 123, 124, 125, 126, 127, 128, 129, 130, 131, 132 and 133. The centralized baseband unit 101 is responsible for managing and processing mobile communications with a plurality of mobile devices within a given geographical area via the remote radio equipment. The remote radio units are collectively responsible for providing direct transmit and receive capabilities between the mobile network and the mobile devices. They relay mobile traffic and other general information to and from the centralized baseband unit 101 via a transport network. The nature of the information carried across this transport network is called fronthaul data. These remote radio equipment can be, in some embodiments, small cell access points such as pico-cells, femto-cells, and the like.

The system 100 comprises a hub located in a central location, referred to as a fronthaul hub 102 and a multitude of remote locations 103, 106, 107, 108, 109, 110 and 111, collectively, the “fronthaul remote units”). In some embodiments, the fronthaul hub 102 may be implemented separately from the baseband unit 101, or be integrated with the baseband unit 101.

Each of the fronthaul remotes may connect to one or multiple remote radio transceiver equipment. For example, fronthaul remote 111 is coupled with remote radio transceiver equipment 133.

The baseband unit 101 is coupled with the fronthaul hub 102 using one or multiple high capacity transmission links, such as link 115. Some of the RRUs are coupled with a fronthaul remote via a high capacity transmission link such as 141 to 145. The fronthaul hub 102 communicates with at least a portion of the fronthaul remote units 103, 106, 107, 110 and 111 using a shared medium and a point to multipoint access method (using fronthaul hub 102, which functions as a shared interface). Communication can comprise an exchange of control and management and user data plus multiple carrier signals (I/Q as described above). The shared medium may be a wireless interface using a block of radio frequency spectrum, or it may be a wireline network, or combinations thereof.

The other fronthaul remotes 104, 105, 108 and 109 are coupled with another using a different fronthaul communication link. For example, fronthaul remote unit 104 is coupled with fronthaul remote unit 103 using fronthaul link 165, and fronthaul remote unit 105 is coupled with fronthaul remote unit 104 using fronthaul link 166.

Fronthaul signals between the baseband unit 101 and the multiple remote radio transceiver units 121 to 133 are transmitted concurrently over the fronthaul hub 102 as a multiplex of fronthaul signals. Thus, the system 100 transmits a multiplex of signals.

The transmission method used between the fronthaul hub 102 and fronthaul remote units 103, 106, 107, 110 and 111 may be based on methods relying on analog conversion of the carrier signals, before being multiplexed, or it may be based on digital transmission techniques for both general information and quantized and sampled carrier signals, with or without compression. The digital fronthaul signals to be transmitted between the fronthaul hub 102 and each individual fronthaul remote units 103, 106, 107, 110 and 111 comprise a multiplex of general information and radio signals. General information signals from the baseband unit 101 are extracted by the fronthaul hub 102 from each individual fronthaul signal and multiplexed and transmitted using digital multiplexing and transmission methods known in the arts.

Carrier signals are transmitted as multiplexes of analog waveforms after being converted to their analog images, as described in greater detail infra. Control signals and analog carrier signals are multiplexed in order to be transmitted on the same medium. Other transmission methods, such as compressed or uncompressed digital fronthaul (whereby control and carrier signals are transmitted as a flow of quantized in-phase and quadrature carrier samples, which are pre-processed or not) are however also applicable within the system 100.

Multiplexing techniques known in the arts, such as frequency division multiplex, wave division multiplex or time division multiplex, or a combination of those may be used to multiplex the signals described above.

Information destined to—or received from—the various fronthaul remotes is categorized according to a unique identification method, in order to facilitate reception by the relevant remote unit and multiplexing by the fronthaul hub, using techniques employed by traditional point to multipoint transmission protocols (either on a static basis, or on a dynamic basis). Exemplary methods include a predetermined scheduling of fronthaul timeslots whereby each remote is allocated a specific time period to transmit and receive, or a predetermined frequency domain multiplex, or again a mix of those two methods. Alternative methods may rely on transmitting an identification of the time or frequency resource on both uplink and downlink in order to manage a dynamic multiplexing method in a point to multipoint network topology. The latter case is beneficial for the transport of bursty or bandwidth variable fronthaul channels. In this case, the network will be required to allocate specific resources for the general information in digital format and specific resources for the multiple carrier representations, in the same manner as current methods of point to multipoint protocols.

Similarly, suitable timing advance management techniques are required in order to guarantee efficient management of the point to multipoint network (in order to avoid collisions on the uplink for instance).

Thus the wireless or wireline resources used to transport fronthaul signals (the shared fronthaul medium) can be shared between links extending between the fronthaul hub and the fronthaul remotes. The system 100 is configured to implement one or more methods to efficiently share the available resources without losing performance or reliability, or with minimal impact on performance and reliability. Such multiplexing methods can benefit particularly in the case where the point-to-multipoint system 100 is used to interconnect a high density of cellular sites, where the wireless or wireline resources are shared between large numbers of links.

In particular, small cells may be implemented using the point to multipoint System, with lower power remote radios creating smaller coverage areas (e.g. pico-cells). Typically, those pico-cells will only serve a small number of mobile users—maybe a few dozen users instead of the several hundreds of users served by a regular large cell. In addition, such a network may be designed to operate with a very high spectral efficiency on both the uplink and the downlink, due to the proximity of the mobile transceivers (mobile devices) in the coverage area and the centralized coordination and interference reduction by the baseband unit 101. Therefore, each pico-cell will operate with a low loading factor and is only required to use a fraction of the available mobile network frequency and time-domain resources of their respective mobile frequency channel (the “wireless resources”, for instance LTE Resource Blocks). This would be the case, for instance, when a particular cell restricts the usage to a subset of the wireless resources available to that cell to serve the limited number of users located on that cell. The system 100 may therefore be able to detect partial usage of the available wireless resources and use this partial use of resources to allocate resources on the shared fronthaul media as well.

Detection of the resource usage may be performed and coordinated within the centralized baseband unit 101 and communicated to the fronthaul hub 102, or within the fronthaul hub 102.

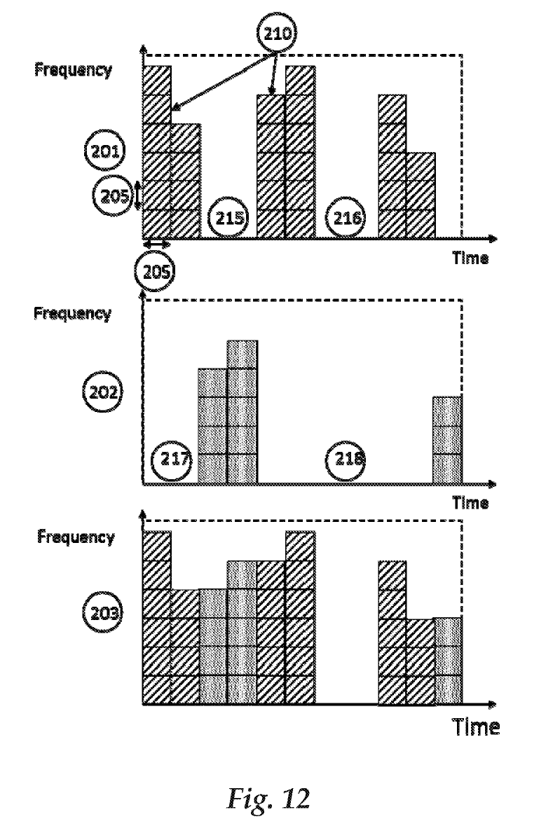

In the particular case of an LTE network, the wireless resource comprises a multitude of LTE Resource Blocks as illustrated in FIG. 12. Depending on the time or on the actual remote radio unit, the network loading may fluctuate therefore the baseband unit 101 may allocate the LTE Resource Blocks differently to various Remote Radio Units. The resource allocation is performed by the baseband unit 101, or with an adjunct unit or functional module associated with it, for all the remote radio units it is coupled with. The resource allocation for a first remote radio unit covering a given cell is illustrated in a graph 201 representing the usage of the radio frequency subcarriers by time intervals (generally of 0.5 ms). For each element of time (or timeslot) 205, the baseband unit 101 may allocate a number of blocks of subcarriers 206 (generally a block of 12 contiguous sub-carriers in the 3GPP LTE standard), which may be contiguous or not, and this allocation may differ from timeslot to timeslot. The sub-carrier block allocated during the timeslot period is called a Resource Block (210). Resource allocation is performed using units of LTE Resource Blocks 203. At any given time, the remote radio units are instructed by the baseband unit 101 to transmit using a set of Resource Blocks that varies in time. In particular, not all resource blocks are used at certain time, and there are times such as 215 and 216 when no resource blocks are transmitted at all. Similarly, the same operation is done for all other remote radio units within the network, according to resource allocation chart 202, which also includes representations of LTE resource blocks. In this case also, the baseband unit 101 may not transmit all resource blocks at certain times, and no resource blocks are used during periods 217 and 218. The fronthaul data is then transferred to the fronthaul hub 102 which may multiplex those two fronthaul channels according to a scheme as illustrated in 203 in order to transmit on the shared medium.

In one embodiment, the centralized baseband unit 101 is the sole coordinator and controller of the use of resources while the fronthaul hub 102 functions transparently and multiplexes the two channels without modifying the allocation of resource blocks at any given point in time. In other embodiments the fronthaul hub 102 can detect the use of the various resource blocks on all the fronthaul channels it manages, and it can thus optimize the use of the shared fronthaul media resources accordingly. In the latter case, digital or analog techniques may be used to alter the frequency assignments of the incoming signal, and it will be the task of the corresponding fronthaul remote to re-order the resource blocks into the original configuration before passing on the signal to the corresponding remote radio unit. One exemplary method may involve transposition of the fronthaul signal into the frequency domain at the fronthaul hub, for instance using Fast Fourier Transforms, and re-arranging the time and frequency allocations over the shared fronthaul medium, and then performing reverse operations at the remote sides of the fronthaul transport network.

Another exemplary method may also take into account known propagation characteristics over a particular fronthaul link, and adapt the use of the shared fronthaul medium resources in order to further optimize the use of the shared fronthaul medium.

Thus, each of the fronthaul remotes are configured to reconstruct the altered resource blocks according to a schema provided by the fronthaul hub 102 or other network resource such as the baseband unit 101.

As can be seen from graph 203, the fronthaul traffic between the baseband unit 101 and two remote radio units can be accomplished on a single channel thanks to an efficient multiplexing scheme taking advantage of the inherent multiplexing features of the baseband unit 101 that may be enhanced by the fronthaul hub 102.

Note that this process may be applied in the uplink direction (from the remote radio units to the baseband unit via the fronthaul remotes and the fronthaul hub 102) as well as the downlink direction (from the baseband unit 101 to the remote radio units via the fronthaul hub 102 and the fronthaul remotes).

It is noteworthy to mention that such process can be simplified as a static process whereby the baseband unit 101 or the fronthaul hub 102 reserves fixed and non-overlapping allocations of timeslots for fronthaul channels (e.g., links) and individual fronthaul remotes. In this case, the fronthaul hub and fronthaul remotes may be optimized to transmit the fronthaul data and signals to each remote for each timeslots. For instance, antenna beamforming techniques may be employed to optimize the transmission towards the corresponding fronthaul remote during each of the timeslots.

The above transmission and multiplexing method may be implemented using a wireless medium or various types of wireline or fiber media, or using a combination of both, between a centralized baseband unit and remote fronthaul units sharing this channel.

In another embodiment the system 100 can be configured to utilize a fixed frequency allocation between the various fronthaul channels and associated remote radio units such that a given fronthaul channel and remote radio unit are assigned a group of frequency blocks by the baseband unit 101 or the fronthaul hub 102.

The system 100 can implement a fully dynamic process to assign timeslots and frequency blocks independently for each timeslot. In this case, the fronthaul hub 102 adapts to the allocation on both the uplink and the downlink accordingly. A given remote radio transceiver equipment is only using a fraction of the wireless resources available to the system 100 at any given time. This could be done using a dynamic method where the use of the wireless resources in each given cell or sector may vary in time and according to each cell or sector. For instance the baseband unit 101 or the fronthaul hub 102 can comprise a scheduler that coordinates scheduling of wireless resources in each small cell so as to coordinate the use of each cell's or sector's use of wireless resources in a given time interval. In this case, specific signaling may be required in order to keep the remote fronthaul units aware of their transmit and receive timeslots or frequency assignments.

The fronthaul hub can either act transparently on the fronthaul signals sent by baseband unit 101, or by actively and directly exploiting the resource allocation and scheduling mechanisms employed by the baseband unit 101. In another exemplary method, the fronthaul hub 102 may cooperate with the baseband unit 101 in the allocation process based on its management of the fronthaul medium.

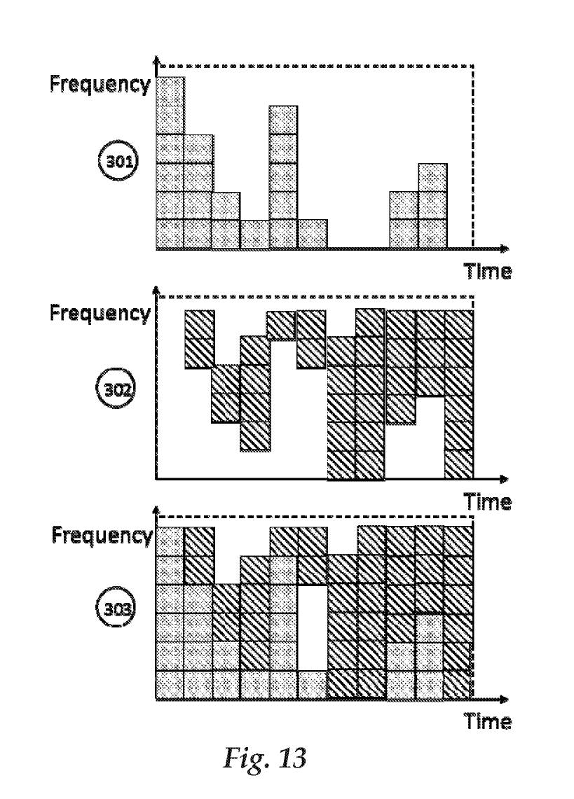

In summation, some embodiments utilize an allocation process based only on timeslots. Other embodiments involve allocation processes initiated by the baseband unit 101 and enhanced by the fronthaul hub 102 using frequency domain in order to multiplex the various fronthaul channels. An example of this cooperative allocation using frequency domain is illustrated in FIG. 13. A graph 301 that comprises wireless resource allocation for a cell or sector of the system 100 is illustrated. Graph 302 illustrates wireless resource allocation for a different cell or sector of the system 100.

Graph 303 illustrates the combination of wireless resource allocations for both sets of cells or sectors, which can occur in parallel with one another based on frequency.

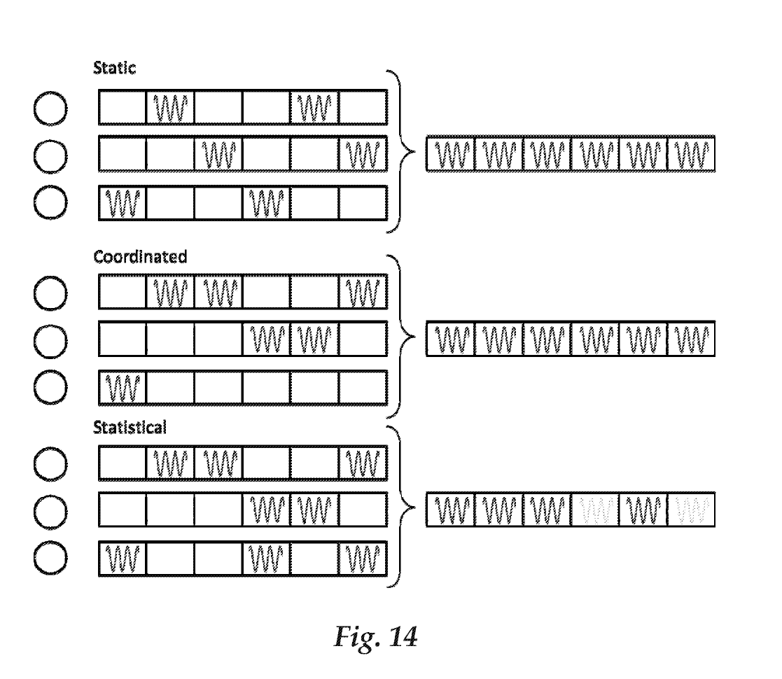

In another embodiment, a statistical approach may be implemented whereby multiplexing of the fronthaul channels is not fully orthogonal which may result in interference at a particular point in time and on certain blocks of frequency sub-carriers, while still providing an acceptable level of performance and availability. These approaches are illustrated in FIG. 14. It is also noteworthy that the wave signs on FIG. 14 denote that the signals are subject to at least some kind of interference and thus signal degradation may occur.

As an enhancement to the previous exemplary method, interference mitigation techniques may be employed to reduce the impact of interference on portions of the shared fronthaul medium used concurrently by several remote transceivers.

In some embodiments, the baseband unit 101 can be configured to reuse certain resource blocks for multiple remote radio units such as when the baseband unit 101 assumes some mobile terminals are sufficiently isolated from cell edge interference in certain cells to allocate certain resources used in neighboring cells. In this case, the fronthaul hub 102 detects those isolated mobile terminals and uses other multiplexing techniques to avoid interference. For instance, antenna beamforming or MIMO techniques can be implemented in order to maintain a high level of de-correlation between the fronthaul channels.

Some resource blocks may be unassigned after the multiplexing process. The system 101 may use these resource blocks to transport general data such as control and management or user data.

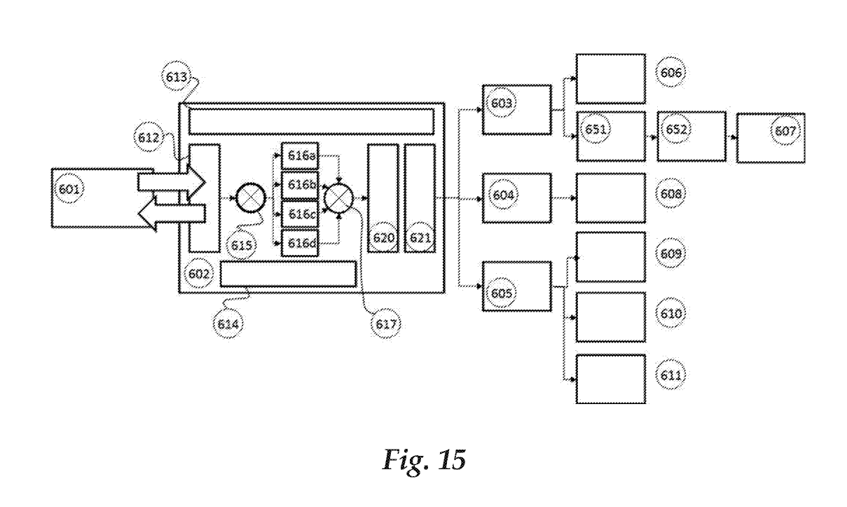

FIG. 15 illustrates another example embodiment of a system 1200 that is configured for use in accordance with the present disclosure. The system 1200 can be used for transporting fronthaul information on a point to multipoint basis. A baseband unit (BBU 601) sends and receives fronthaul information to fronthaul hub 602 in digital format based on a fronthaul standard, and on one or several physical or logical ports. Fronthaul hub 602 comprises a fronthaul frontend interface module 612, management function 613, optional scheduler 614, digital fronthaul demultiplexer, 615, conversion units 616a, 616b, 616c and 616d, fronthaul multiplexing unit 617, transmission module 620, transmission coupling unit 621.

BBU 601 transmits and receives formatted fronthaul signals on the shared medium using a fronthaul hub 602. The shared medium enables communication with remote radio transceivers 606, 607, 608, 609, 610, 611, 651 and 652, via fronthaul remote units 603, 604 and 605 located at a distance from fronthaul hub 602.

Fronthaul hub 602 comprises a frontend interface module 612 to interface with the fronthaul interface to the BBU. Frontend interface module 612 is functionally and communicatively coupled to digital fronthaul demultiplexer 615. Digital fronthaul demultiplexer separates the plurality of fronthaul links between BBU 601 and the plurality of remote radio transceivers 606, 607, 608, 609, 610, 611, 651 and 652 into separate traffic flows.

Conversion units 616a, 616b, 616c and 616d separate the digital control and management and user data from the digital I/Q data and converts each flow into either a digital flow in the case of the control and management and user data, and an analog representation of the carrier signal in the case of the digital I/Q data. This operation is done in the manner described in U.S. Pat. No. 8,761,141, which is incorporated by reference in its entirety herein. The resulting signals are then fed into fronthaul multiplexer 617.

Fronthaul multiplexer 617 organizes the plurality of analog and digital signals in order to enable their transmission on the shared medium. To be sure, fronthaul links to those sites may not be active all the time, and the periods of inactivity may be used to transmit other links on the same medium. In an exemplary embodiment, fronthaul multiplexer 617 may analyze the nature of the fronthaul signal to be transmitted, in the temporal and frequency domains, and implement a multiplexing method taking into account any available time and frequency resources to optimize the efficiency of the fronthaul transmission. In another exemplary embodiment, the fronthaul multiplexer may also take into account known propagation characteristics of the fronthaul links to be multiplexed to further optimize multiplexing and transmission efficiency.

The output of the multiplexer 617 is therefore a combination of various signals, analog and digital, multiplexed for transmission on the shared fronthaul medium. The output is then fed into transmission module 620, which is communicatively coupled with coupling unit 612 for transmission on the shared medium.

Fronthaul remote units 603, 604 and 605 are statically or dynamically configured to receive from and transmit to the fronthaul hub on the shared medium. As such they only process the part of the signal relevant to the remote radio transceivers to which they are communicatively coupled. As an exemplary embodiment, they may receive or transmit the portion of the fronthaul medium corresponding to the allocation in the temporal and frequency domain, as allocated by the fronthaul hub for transmission to the corresponding fronthaul remote module. They perform the reverse operation as 616a, 616b, 616c and 616d. Therefore their output towards the remote mobile transceivers 606, 607, 608, 609, 610, 611, 651 and 652 is a digital combination of control, management and user data and digital I/Q information pertaining to the RF carriers destined for their respective remote radio transceiver equipment.

In some embodiments, the BBU 601 together with the fronthaul hub 602 coordinates the transmission from the BBU 601 to the remote radios transceivers and the transmission from the remote radios transceivers to the BBU 601 so as to avoid or minimize interference between the fronthaul links to and from the remote units. Again, the BBU 601 and the fronthaul hub 602 can perform this coordination in the time domain or in the frequency domain or in a combination of these domains, or again using orthogonal or pseudo-orthogonal codes as a means of multiplexing. In some embodiments, the BBU 601 may be in full control of the coordination and optimization of fronthaul resources with the fronthaul hub 602 being mostly transparent. In other embodiments, the fronthaul hub may actively rearrange the fronthaul transmission towards the multiple fronthaul remote units 603, 604 and 605, based on its analysis of the signal to be transmitted and the conditions of fronthaul links. In yet other embodiments, the BBU 601 and fronthaul 602 may collaboratively manage the efficient transmission and multiplexing of the fronthaul signals to the fronthaul remote units 603, 604 and 605.

A scheduler (optional element 614) can be utilized, in conjunction with multiplexer 617, to allocate only a part of the wireless resource, such as for example subcarriers in a multicarrier modulation scheme, on a dynamic basis.

Advantageously, this coordination not only alleviates the amount of access resources used (power, timeslots, frequency sub-carriers), it also creates an opportunity to save on fronthaul resources. These methods can also be utilized to multiplex several links on the same channel (e.g. same wire, same wavelength on a fiber, same wireless spectrum band or channel).

With respect to how the system handles digital information, the digital information can be time division multiplexed based on activities of the respective small cell or group of small cells. Compressed or uncompressed transmissions are both applicable to the system.

With respect to how the system handles analog carrier signals, the analog carrier signals can be transmitted using time division, for instance based on a static time domain partitioning, whereby carrier signals are transmitted and received only during this fixed time assignment. Transmission and reception of control and management or user data can either be transmitted on another frequency carrier during the same time partitions for the given fronthaul link, or it may be transmitted and received only during a specific time period within the time partition corresponding to the given fronthaul link.

In one particular embodiment, fronthaul interface time partitioning may be synchronized with baseband activity. In this case, the baseband unit is directly or indirectly involved in allocating fronthaul interface resources and in optimizing its use.

Frequency division can also be utilized where static partitioning is used for both carrier signals and Control and Management and User data (on different carriers). One embodiment could include frequency allocation on the fronthaul interface operated as a function of the frequency multiplexing operated by baseband processing at the BBU 601. This case assumes that the BBU is involved in resource allocation on the fronthaul interface.

In yet another embodiment, multiplexing the various fronthaul links to the at least one remote radio units may be realized by assigning orthogonal spreading codes (such as for example direct sequence of frequency hopping codes) and spreading the fronthaul signals using those codes, such as to created orthogonal fronthaul channels to each remote mobile radio units.

Coordinated multiple access techniques may also be used in order to allocate frequency and time resources dynamically for the purpose of establishing fronthaul links to the remote radio units, when required and with the bandwidth as required. Dynamic fronthaul bandwidth allocation may be performed either at the BBU 601 or in an adjunct entity responsible for managing fronthaul resources and access.

In some embodiments, the system can implement random access with no central coordination by the BBU 601 in order to transmit either Control and Management and User data as well as the analog carrier signals. While this may result in collisions and consequently interference between fronthaul channels, mitigation techniques such as selective retransmission or combining, or such as antenna diversity techniques may be used to reduce or null the interfering signal, by incorporating those mechanisms in the fronthaul central and remote radio units' transmission protocol.

In general, the network topologies that are improved by the features of the present disclosure include, but are not limited to, point-to-point, point-to-multipoint, multi-point to multi-point and mesh networks.

In some embodiments, the systems can utilize a shared fronthaul medium that can comprise wireless medium, wireline medium, and combinations thereof.

Methods that can be improved using the features of the present disclosure include but are not limited to statistical time division scheme (e.g. sensing before transmitting), scheduled time division scheme (multipoint system), and static schemas, just to name a few.

In some embodiments, the fronthaul hub implements the sharing method and optimizes it so that the multiplexed signals occupy the least amount of resource. In other embodiments, the fronthaul hub coordinates with the BBU for scheduling the fronthaul resources and may additionally emulate events on the fronthaul interface carrying the RF carriers in order to trigger actions by certain functions of the BBU. For instance, by transmitting at certain times and on certain frequencies on a given fronthaul channel, the fronthaul hub may cause the BBU to adapt its scheduling, resource allocation or interference mitigation techniques and algorithms in such a way as to offer a more optimized use of the shared fronthaul interface resources.

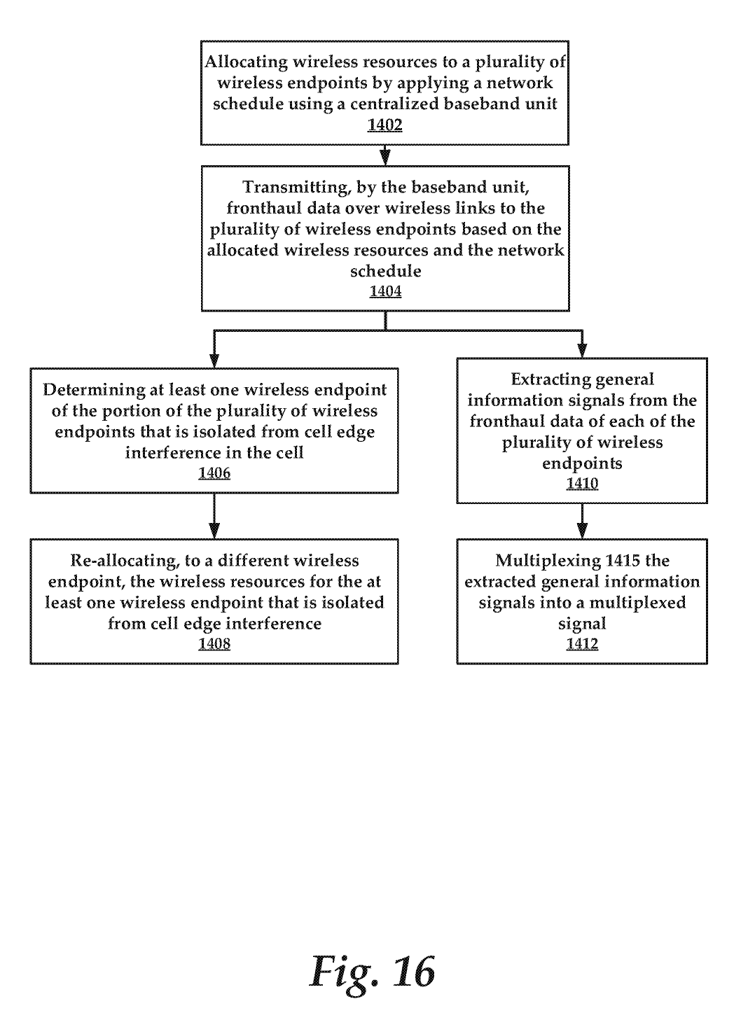

FIG. 16 illustrates an example method of efficient transmission of fronthaul data in small cell networks. The method includes allocating 1402 wireless resources to a plurality of wireless endpoints by applying a network schedule using a centralized baseband unit. Allocation can occur in the time, frequency, and time/frequency domains.

In some embodiments, the method includes transmitting 1404, by the baseband unit, fronthaul data over wireless links to the plurality of wireless endpoints based on the allocated wireless resources and the network schedule.

According to some embodiments, the method includes a sub-method that comprises determining 1406 at least one wireless endpoint of the portion of the plurality of wireless endpoints that is isolated from cell edge interference in the cell. For example, a mobile terminal may be physically spaced apart from other mobile terminals in the same cell (or adjacent cells). The transmissions to and from the isolated mobile terminals are not likely to cause interference. Thus, the resources allocated to the isolated mobile terminal can be reallocated to a different cell or mobile terminal that needs scheduling and allocation because of interference.

Thus, the method comprises re-allocating 1408, to a different wireless endpoint, the wireless resources for the at least one wireless endpoint that is isolated from cell edge interference. In some embodiments, beam forming can be used to transmit fronthaul data to the isolated wireless terminal, due to the terminal being taken off of the wireless resource allocation schedule.

Another example sub-method can comprise extracting 1410 general information signals from the fronthaul data of each of the plurality of wireless endpoints, as well as multiplexing 1412 the extracted general information signals into a multiplexed signal.

The sub-methods can be executed individually or cooperatively by the system configured to perform the method. Not all method steps are required and the present disclosure is not limited to the examples provided in the flowchart.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be communicatively coupled with the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A system that efficiently transmits fronthaul data, the system comprising:
a plurality of remote fronthaul unit equipment devices, each coupled with at least one remote radio transceiver and transmitting and receiving fronthaul data to and from the at least one remote radio transceiver; and
a fronthaul hub that is coupled to a baseband unit at a first location that is coupled to the plurality of remote fronthaul units equipment devices over fronthaul links, the fronthaul hub managing allocation of fronthaul resources to the plurality of remote fronthaul units equipment devices and transmitting and receiving fronthaul data to the plurality of remote fronthaul units equipment devices using a multiplexing schema, the fronthaul data comprising control and management data, user data and digital RF carrier signals.

2. The system according to claim 1, wherein the fronthaul links comprise any of wireless links, wireline links, and combinations thereof.

3. The system according to claim 1, wherein the fronthaul hub utilizes a scheduling schema that comprises time domain allocation of the fronthaul resources.

4. The system according to claim 1, wherein the fronthaul hub utilizes a scheduling schema that comprises frequency domain allocation of the fronthaul resources.

5. The system according to claim 1, wherein the fronthaul hub utilizes a multiplexing schema that comprises spreading the control and management and user data, and the fronthauled carrier signals using orthogonal spreading codes before transmitting it on the fronthaul interface.

6. The system according to claim 1, wherein the fronthaul hub positioned between the baseband unit and the plurality of remote fronthaul unit equipment devices is coupled with the baseband unit in order to cooperate for efficient allocation and management of wireless resources rather than the baseband unit.

7. The system according to claim 6, whereby the fronthaul hub analyzes and processes content of the data and signals transmitted or received to or from the baseband unit, on a fronthaul interface.

8. The system according to claim 1, wherein at least one of the carrier signals is converted into an analog signal prior to multiplexing and transmitting on a shared fronthaul medium, and converted back to digital format upon reception by the remote fronthaul unit prior to transmitting to the remote radio transceiver, or by the fronthaul hub prior to transmitting to the baseband unit.

9. A method, comprising:
allocating fronthaul resources to a plurality of fronthaul endpoints by applying a network multiplexing or schedule using a fronthaul hub unit communicatively coupled with a centralized baseband unit; and
transmitting, by the fronthaul hub, fronthaul data over fronthaul links to the plurality of remote fronthaul unit equipment devices based on the allocated fronthaul resources and the network multiplexing scheme or schedule.

10. The method according to claim 9, wherein allocating utilizes any of time domain, frequency domain, and combinations thereof.

11. The method according to claim 9, further comprising multiplexing fronthaul data for a portion of the plurality of remote fronthaul unit equipment devices that are not fully orthogonal to one another.

12. The method according to claim 9, wherein a portion of the plurality of remote fronthaul unit equipment devices, each covering a mobile network cell, further comprising:
determining at least one remote fronthaul unit equipment device of the portion of the plurality of remote fronthaul unit equipment devices being communicatively coupled with a mobile terminal that is isolated from cell edge interference in the cell; and
re-allocating, to a different remote fronthaul unit equipment device, wireless resources for the mobile terminal that is isolated from cell edge interference.

13. The method according to claim 9, further comprising utilizing beam forming to transmit the fronthaul data to at least one remote fronthaul unit equipment device and to minimize interference from other remote fronthaul unit equipment devices using a same shared fronthaul medium.

14. The method according to claim 9, further comprising:
extracting general digital information signals from the fronthaul data of each of the plurality of fronthaul endpoints; and
multiplexing the extracted general information signals into a multiplexed signal.

15. The method according to claim 14, wherein at least a portion of the digital RF carrier signals is converted to an analog signal prior multiplexing.

16. A system, comprising: a hub communicatively coupled with a baseband unit and a plurality of fronthaul remotes coupled with remote radio transceivers over communications links, each communications links is used to transport fronthaul data towards the remote radio transceivers which comprise at least one radio frequency transceiver, wherein fronthaul resources are allocated using multiplexing or network scheduling and at least one resource allocation schema.

17. The system according to claim 16, wherein allocation and formatting of the fronthaul data and signals is performed by the baseband unit and wherein an external device implements management and scheduling of resources on the system, based on a nature and characteristic of the fronthaul data and signals allocated and formatted by the baseband unit.

18. The system according to claim 17, wherein the remote radio transceivers analyze the fronthaul data and signals in the frequency and time domains in order to determine the allocation of resources implemented by the baseband unit for transmission to the plurality of remote radio transceiver, so as to optimize the multiplexing of the fronthaul signals and data on the fronthaul transport network, using the shared fronthaul medium.

19. The system according to claim 18, wherein the remote radio transceivers use feedback from the plurality of remote fronthaul units in order to determine information about fronthaul links to these units and to optimize allocation of fronthaul resources and transmission to the fronthaul remotes based on that information.

20. The system according to claim 16, wherein the remote radio transceivers provide feedback to the baseband unit in order to trigger subsequent resource allocations by the baseband unit in order to facilitate or optimize allocation of resources on the fronthaul interface.

21. The system according to claim 16, further comprising a scheduler associated with the baseband unit, wherein the scheduler is configured to allocate a portion of the fronthaul resources in addition to wireless resource between one of the remote radio transceivers and a mobile device it is communicatively coupled with on the mobile radio network.
